(19) United States
(12) Patent Application Publication
(10) Pub. No.: US 2024/0173982 A1
(43) Pub. Date: May 30, 2024

(54) Inkjet nozzles cleaning in a digital printing system

(71) Applicant: Landa Corporation Ltd., Rehovot (IL)

(72) Inventors: Benzion Landa, Nes Ziona (IL); Ronen Lalezar, Rishon Lezion (IL); Haggai Karlinski, Ramat Gan (IL); Alon Moldavski, Ashkelon (IL); Dan Bavli, Kidron (IL); Nir Freund, Yavne (IL); Ran Vilk, Kiryat Ono (IL)

(21) Appl. No.: 18/549,362

(22) PCT Filed: Mar. 13, 2022
(86) PCT No.: PCT/IB2022/052234

§ 371 Date: Sep. 7, 2023

Related U.S. Application Data
(60) Provisional application No. 63/162,577, filed on Mar. 18, 2021.
(60) Provisional application No. 63/214,286, filed on Jun. 24, 2021.

(51) Int. Cl. B41J 2/165; B32B 5/02; B32B 5/26; B32B 27/12; B32B 27/20; B32B 27/32; B32B 27/36; B41J 13/00

(52) U.S. Cl. CPC B41J 2/16552; B32B 5/022; B32B 5/024; B32B 5/277; B32B 27/12; B32B 27/20; B32B 27/32; B32B 27/36; B41J 13/0027; B32B 2432/00; B41J 2002/16558; B41P 2235/20

(57) ABSTRACT

A system (10) having a printing position and a non-printing position, the system (10) includes an image forming station (60) and a wiping assembly (200, 400). The image forming station (60) including at least a nozzle plate (61) having one or more nozzles (166, 166a, 166b, 166c), which are configured to apply droplets of a printing fluid onto a surface of one or more substrates (44) for producing one or more images thereon. The wiping assembly (200, 400) is at least partially positioned in a gap (141) between the nozzle plate (61) and the one or more substrates (44), and is configured, while the system (10) is in the printing position, to (i) make physical contact with the nozzle plate (61) and (ii) remove residues of the printing fluid from at least one of the nozzles (166, 166a, 166b, 166c).

### CROSS-REFERENCE TO RELATED APPLICATIONS

This application claims the benefit of U.S. Provisional Patent Application 63/162,577, filed Mar. 18, 2021, and U.S. Provisional Patent Application 63/214,286, filed Jun. 24, 2021, whose disclosures are all incorporated herein by reference.

### FIELD OF THE INVENTION

The present invention relates generally to digital printing systems, and particularly to methods and systems for preventing clogging of inkjet nozzles in digital printing systems.

### BACKGROUND OF THE INVENTION

Various techniques for maintaining cleanliness and functionality of nozzles in inkjet printing systems have been published.

For example, Japanese Patent Application publication 2000103086A describes an inkjet printer having an inkjet head and a transfer belt. The inkjet head comprises multiple nozzles for ejecting ink on the transfer belt, which is further transferred to the recording paper. A maintenance unit is used for a maintenance process of the inkjet head comprising a pull-out roller, a roller, and a maintenance sheet (a wiping sheet). The maintenance sheet is pulled out from the maintenance unit by the pull-out roller and the print head is then moved upwards. The roller and the pull-out roller serve as pull-out members for horizontally pulling out the maintenance sheet. As the take-up roller is driven to rotate, the maintenance sheet is moved from a supply roller through the pull-out roller to the take-up roller. When the maintenance sheet is moved, the nozzle surface is wiped off by the maintenance sheet and the wiping operation takes place.

U.S. Pat. No. 10,449,767 describes a liquid ejecting apparatus that includes: a liquid ejecting head which ejects liquid from a nozzle that is disposed on a nozzle surface, a wiping member with a lengthwise shape that is capable of contacting the nozzle surface, a contact portion that is capable of contacting the side opposite to the side on which the wiping member contacts the nozzle surface, and a transport mechanism that transports the wiping member, in which the contact portion has a first contact portion which is separated from the wiping member when the wiping member is transported by the transport mechanism, and which contacts the wiping member when the wiping member is driven to contact the nozzle surface, and a second contact portion which contacts the wiping member when the wiping member is transported by the transport mechanism.

U.S. Pat. No. 8,888,230 describes a fluid ejecting apparatus that includes: a fluid ejecting head which includes nozzle rows each having a plurality of nozzles and ejects a fluid onto a medium, the fluid ejecting apparatus being capable of performing a flushing operation in which the fluid is ejected to an absorbing member used to absorb the fluid ejected from the nozzles, wherein the absorbing member is a linear member which extends along the nozzle row and is capable of relatively moving to a position retracted from a flying path of the fluid ejected from the nozzles.

U.S. Pat. No. 5,557,307 describes a cleaning thread for inkjet printing nozzles. An adsorbent material is mounted on a nozzle plate of an inkjet printer to collect extraneous ink and particles that might otherwise clog the nozzle orifices of the printer. In inkjet printers, ink droplets are propelled from an array of orifices in a nozzle plate in the printer head. During the ink droplet ejection, ink is sprayed or deposited around the orifices. The ink droplets are deposited on a paper web adjacent to the nozzle, and mist from the droplets drifts back to coat the face of the nozzle plate. This ink-coating attracts particles that tend to clog the nozzle orifices. By locating an adsorbent material in close proximity to the nozzle orifice array, the material adsorbs and removes ink that coats the nozzle plate before the ink clogs the orifices of the nozzle. A thread is an example of an adsorbent material. The thread slides in a groove across the face of the nozzle plate to draw off the ink-coating and particles on the nozzle plate. A thread-dispenser bobbin on one side of the printer head supplies clean thread to the printer head, and a rewind bobbin on the other side of the printer head draws the thread across the nozzle plate and off the dispenser bobbin.

Chinese Patent Application Publication 100553982C describes an inkjet coating apparatus comprising a shower nozzle with a plurality of nozzles whose solution is sprayed to a substrate using ink-jetting, and a rag with absorptive band shape. The rag is discarded to a discharging gear release mechanism in front of the nozzle face of shower nozzle, and the rag is pressed to the roller on the nozzle face.

### SUMMARY OF THE INVENTION

An embodiment of the present invention that is described herein provides a system having a printing position and a non-printing position, the system including an image forming station and a wiping assembly. The image forming station including at least a nozzle plate having one or more nozzles, which are configured to apply droplets of a printing fluid onto a surface of one or more substrates for producing one or more images thereon. The wiping assembly is at least partially positioned in a gap between the nozzle plate and the one or more substrates, and is configured, while the system is in the printing position, to (i) make physical contact with the nozzle plate and (ii) remove residues of the printing fluid from at least one of the nozzles.

In some embodiments, the system includes (i) a transport assembly, which is configured to move the one or more substrates relative to the nozzle plate, and (ii) a processor, which is configured to control: (a) the transport assembly to move the one or more substrates, and (b) the wiping assembly to remove the residues from at least one of the nozzles while the one or more substrates are moved by the transport assembly. In other embodiments, in the printing position, the processor is configured to retain a constant throughput of producing the one or more images, including during removing the residues by the wiping assembly. In yet other embodiments, the one or more substrates include an intermediate transfer member (ITM), which is configured to receive the droplets for producing the one or more images, and to transfer the one or more images to a target substrate, and the transport assembly includes an ITM module, which is configured to move the ITM relative to the image forming station for producing the one or more images.

In an embodiment, the one or more substrates include one or more sheets or a continuous web, and the transport assembly includes a substrate transport module, which is configured to move the one or more sheets or the continuous web relative to the image forming station so as to produce the one or more images thereon. In another embodiment, the image forming station includes at least a first print bar having one or more first nozzles and a second print bar having one or more second nozzles, and in the printing position, the wiping assembly is configured to remove the residues from at least one of the first nozzles while at least one of the second nozzles apply the droplets. In yet another embodiment, in the printing position, the gap between the nozzle plate and the one or more substrates is retained while (i) applying the droplets, and (ii) removing the residues.

In some embodiments, the wiping assembly includes a wiping element, which is configured to remove the residues by wiping the residues of the printing fluids from at least an orifice of at least one of the nozzles. In other embodiments, the wiping element includes a ribbon, which is configured to hold a cleaning fluid and to make the physical contact with the nozzle plate by self-adhering to the nozzle plate. In yet other embodiments, the ribbon includes: (a) a residues-removing layer, which is configured to remove residues of printing fluids from the nozzle plate, and (b) a compressible layer, which is coupled to the residues-removing layer, and is configured to: (i) absorb and contain a cleaning fluid when placed in contact with the cleaning fluid, and (ii) release at least part of the cleaning fluid when a compression force is applied to the ribbon.

In an embodiment, the wiping assembly is configured to position the ribbon over at least one of the nozzles when the image forming station is not applying the droplets to the substrate. In another embodiment, the ribbon is configured for capping the nozzles, and the compressible layer is configured to retain humidity in the ribbon so as to prevent solidification of the residues or another substance on the nozzles. In yet another embodiment, the ribbon is configured to: (i) hold a predefined amount of the cleaning fluid for wiping the residues disposed on the nozzles, and (ii) absorb additional residues of the printing fluids that are not disposed on the nozzles.

In some embodiments, the additional residues include at least one of vapors and aerosols of the printing fluids, and the wiping element is configured to absorb at least one of the vapors and aerosols of the printing fluids that are not disposed on the nozzles. In other embodiments, the wiping assembly is configured to move the wiping element within a gap between the nozzles and the one or more substrates for at least one of: (i) wiping the residues disposed on at least one of the nozzles, and (ii) absorbing additional residues of the printing fluids that are positioned between the nozzles and the one or more substrates. In yet other embodiments, the wiping assembly is configured to move the wiping element in a first direction during a first-time interval, and in a second direction during a second-time interval.

In an embodiment, the nozzles are arranged along a first axis and across a second axis, and at least one of: (i) the first direction is parallel to the first axis, and (ii) the second direction is parallel to the second axis. In another embodiment, the one or more substrates are moved in a moving direction, the first direction is parallel to the moving direction, and the second direction is orthogonal to the moving direction. In yet another embodiment, the processor is configured to control the wiping assembly to move the wiping element in at least one of the first and second directions when at least one of the nozzles is jetting the printing fluids toward the one or more substrates.

In some embodiments, the first-time interval is larger than the second-time interval. In other embodiments, the first-time interval overlaps with one or more second-time intervals. In yet other embodiments, the first direction is orthogonal to the second direction.

In an embodiment, the processor is configured to control the wiping assembly to move the wiping element (i) at a first speed in the first direction, and (ii) at a second speed, which is different from the first speed, in the second direction. In another embodiment, the second speed is at least five times larger than the first speed. In yet another embodiment, the one or more substrates include a flexible substrate having a first section for receiving the one or more printing fluids and a second section positioned between the first and second images, and, the processor is configured to control (i) the flexible substrate to be moved in a moving direction, and (ii) the wiping assembly to move the wiping element in the second direction, which is parallel to the moving direction of the flexible substrate, when the second section passes adjacent to one or more nozzles.

In some embodiments, the processor is configured to control the wiping assembly to move the wiping element in the second direction, which is parallel to the moving direction of the flexible substrate, when the one or more nozzles are not applying the droplets. In other embodiments, during at least part of the second-time interval, at least part of the wiping element is positioned within a gap between at least one of the nozzles and the second section. In yet other embodiments, the processor is configured to: (i) control the image forming station to apply the droplets when the first section passes adjacent to the one or more nozzles, and to not apply the droplets when the second section is adjacent to the one or more nozzles, and (ii) control the wiping assembly to move the wiping element for wiping the residues from the nozzles when the processor controls the one or more nozzles to not apply the droplets.

In an embodiment, the flexible substrate includes an intermediate transfer member, which is configured to receive droplets to form images at the image forming station and to transfer the images to a target substrate. In another embodiment, the second section is configured to connect between two ends of the first section, so as to form an endless loop including the first and second sections. In yet another embodiment, the one or more substrates include a first sheet configured to receive the first image, and a second sheet configured to receive the second image, and the processor is configured to control the wiping assembly to move the wiping element in the second direction after forming the first image and before forming the second image, while at least one of the first and second sheets is moved within the system.

In some embodiments, the system includes a cleaning system, which is configured to remove one or more of the residues from the wiping element. In other embodiments, the image forming station includes one or more print heads, each print head including one or more of the nozzles, and including a substrate transport module, which is configured to move the substrate in a printing direction, for forming the image thereon, the one or more print heads have a first axis parallel to the printing direction and a second axis perpendicular to the printing direction, and, the wiping assembly is configured to remove the residues from the nozzles of at least one of the print heads by moving a wiping element along the first axis of the one or more print heads. In yet other embodiments, the wiping assembly is configured to remove the residues from at least one of the nozzles while moving the wiping element along the second axis of the print head.

In an embodiment, the wiping assembly is configured to remove the residues from at least one of the nozzles while the substrate transport module moves the substrate in the printing direction. In another embodiment, the wiping assembly is configured to remove the residues from at least one of the nozzles when the nozzles do not apply the droplets to the substrate. In yet another embodiment, at least one of the one or more print heads includes a nozzle plate having first and second sections without nozzles and a third section, which is positioned between the first and second sections and includes the nozzles, and the wiping assembly is configured to move the wiping element at least in the first axis from the first section, through the third section for removing the residues, to the second section.

In some embodiments, the wiping assembly is configured to move the wiping element in the second axis when the wiping element is positioned over the first section or the second section. In other embodiments, the wiping assembly is configured to continuously move the wiping element in the first axis, at a predefined frequency, back and forth between the first and second sections. In yet other embodiments, the substrate has multiple first sections and multiple second sections positioned alternately along the substrate in the moving direction, the image forming station is configured to form multiple images on the multiple first sections, respectively, when each of the first sections is facing the image forming station, the wiping assembly is configured to move the wiping element back and forth in the first axis when the second section is facing the image forming station, and, the predefined frequency includes a discrete number of the second section facing the image forming station.

In an embodiment, the predefined frequency is defined by a time interval. In another embodiment, the substrate includes a flexible substrate having first and second ends coupled by a seam section for forming a loop, the flexible substrate is moved in the printing directions in cycles, each of the cycles defined when the seam section is facing the image forming station, and the predefined frequency includes a discrete number of the cycles. In yet another embodiment, the wiping assembly is configured to move the wiping element: (i) along the first axis using a first motion profile, and along the second axis using a second different motion profile.

In some embodiments, the first motion profile includes a continuous motion profile, and the second motion profile includes a discrete motion profile.

There is additionally provided, in accordance with an embodiment of the present invention, a ribbon including: (a) a residues-removing layer, which is configured to remove residues of printing fluids from one or more nozzles of a printing system, and (b) a compressible layer, which is coupled to the residues-removing layer, and is configured to: (i) absorb and contain a cleaning fluid when placed in contact with the cleaning fluid, and (ii) release at least part of the cleaning fluid when a compression force is applied to the ribbon.

In some embodiments, the one or more nozzles are formed in a nozzle plate, and the residues-removing layer is configured to receive at least part of the cleaning fluid from the compressible layer, and to self-adhere to the nozzle plate for making a physical contact with the one or more nozzles. In other embodiments, the ribbon includes a core layer, which is coupled to the compressible layer, and is configured to stiffen the ribbon in a given plane when a tension force is applied to the ribbon. In yet other embodiments, the core layer is implemented within the fluid-containing layer such that the fluid-containing layer has first and second outer surfaces facing one another, and the core layer is positioned between the first and second surfaces.

In an embodiment, the first outer surface is coupled to the residues-removing layer, and including a polyethylene-based layer, which is coupled to the second outer surface of the fluid-containing layer, and is configured to perform at least one of: (i) stiffen the ribbon in the given plane when the tension force is applied to the ribbon, and (ii) retain at least part of the cleaning fluid within the fluid-containing layer when the compression force is not applied to the ribbon. In another embodiment, the polyethylene-based layer includes polyethylene terephthalate (PET). In yet another embodiment, the ribbon is moved in at least one of first and second directions parallel to the given plane, and the core layer and the polyethylene-based layer are configured to stiffen the ribbon in the first and second directions.

In some embodiments, the printing system includes a first nozzle having first printing residues and a second nozzle having second printing residues, and at least one of the residues-removing layer and the fluid-containing layer is configured to compensate for a topographic difference between the first and second nozzles, so as to adhere between (i) the residues-removing layer and (ii) at least the first and second nozzles, for removing the first and second printing residues.

There is additionally provided, in accordance with an embodiment of the present invention, a method including, in a system having a printing position and a non-printing position, applying droplets of a printing fluid, using one or more nozzles of a nozzle plate, onto a surface of one or more substrates for producing one or more images thereon. While the system is in the printing position, a wiping assembly, which is at least partially positioned in a gap between the nozzle plate and the one or more substrates, is applied for: (i) making physical contact with the nozzle plate, and (ii) removing residues of the printing fluid from at least one of the nozzles.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIG. 2 is a schematic side view of a wiping assembly and a cleaning station, in accordance with an embodiment of the present invention;

FIGS. 3A, 3B and 3C are schematic pictorial illustrations of a ribbon moved relative to surfaces of bottom sections of a print bar of the digital printing system, in accordance with an embodiment of the present invention;

FIG. 4 is a schematic pictorial illustration of a wiping assembly, in accordance with an embodiment of the present invention;

FIG. 5 is a schematic sectional view of a ribbon, in accordance with an embodiment of the present invention;

FIG. 6 is a schematic sectional view of a ribbon squeezed in a squeezing assembly, in accordance with an embodiment of the present invention;

FIGS. 7A and 7B are schematic pictorial illustrations of a wiping assembly, in accordance with an embodiment of the present invention;

FIG. 8 is a flow chart that schematically illustrates a method for removing residues from nozzles of a digital printing system, in accordance with an embodiment of the present invention; and

FIG. 9 is a flow chart that schematically illustrates a method for forming images and removing residues from nozzles of a print bar of a digital printing system, in accordance with an embodiment of the present invention.

### DETAILED DESCRIPTION OF EMBODIMENTS

### Overview

Inkjet-based digital printing systems typically produce an ink image by applying (e.g., jetting or spraying) through nozzles, printing fluids such as ink, to a substrate.

One problem in printing systems of this sort is that ink residues may coagulate and clog at least part of a nozzle, which may result in defects and/or distortions in subsequent printed images. For example, partial clogging of an orifice of the nozzle may divert the next ink droplet to land on the substrate at a location that differs from the intended location. As another example, full clogging of the nozzle may result in missing ink at the intended location(s) on the substrate.

In principle, it is possible to periodically stop the printing for performing a maintenance procedure so as to remove the ink residues before coagulation on the nozzles occurs. Such scheduled or unscheduled maintenance, however, reduces the availability and utilization of the printing system, and therefore, reduces the throughput of the system.

Embodiments of the present invention that are described hereinbelow provide methods and systems for preventing distortions in printed images on a substrate by removing ink residues without stopping the printing operation of an inkjet-based digital printing system. The disclosed technique is also referred to herein as an on-the-fly removal of ink residues.

In some embodiments, the digital printing system comprises an image forming station comprising multiple print bars. Each print bar has multiple print heads arranged along a long axis of the print bar, and each print head has a nozzle plate having three sections: (i) a central section positioned, along the long axis, at the center of the nozzle plate and comprising an array of nozzles for jetting ink droplets (or any other suitable printing fluid) on the substrate, and (ii) two side sections that typically have no nozzles and are positioned, along the long axis, at the sides of the central section.

In some embodiments, the image forming station is configured to apply the droplets of ink to the substrate, while the substrate is moved relative to the print heads. The substrate has: (i) first sections, which are intended to receive the ink droplets for forming an image on the substrate, and (ii) second sections, (also referred to herein as non-printable sections or areas) which are typically positioned alternately among the first sections. The second sections are not receiving the droplets of ink, and are not intended for forming images thereon. In some embodiments, one of the second sections may comprise a seam section described in detail below.

In some embodiments, the substrate is moved, in close proximity to the print bars of the image forming station, in a moving direction so as to receive the ink droplets on the first sections. In the present example the moving direction is orthogonal to the long axis of the print bar. In such embodiments, when the substrate is moved, the first and second sections are alternately facing the print bars.

In some embodiments, a processor of the digital printing system is configured to control the image forming station to: (i) direct the ink droplets through the nozzles to the substrate, when a first section of the substrate is facing the print bar, and (ii) refrain from jetting ink droplets toward the substrate when a second section is facing the print bar.

In some embodiments, the digital printing system comprises, for each print bar, a residues-removal assembly, also referred to herein as a wiping assembly (WA), which is controlled by the processor and is configured to wipe ink residues from the nozzles of the respective print heads. The WA comprises a ribbon, and is configured to move the ribbon in two directions over the sections of the nozzle plate. In the present example, when the nozzles are jetting ink droplets on the first section, the WA is configured to move the ribbon continuously along the long axis, over one of the side sections of the nozzle plate, so that the ribbon does not interfere with the jetting process of the ink droplets.

In some embodiments, when the substrate is moved and at least one of the second sections is facing the print bar, the processor is configured to control the WA to move the ribbon at least along a short axis of the print bar, which is typically parallel to the moving direction of the substrate. In such embodiments, the ribbon is moved along the short axis: (i) from a first side section of the nozzle plate, (ii) over the nozzles of the central section, so as to wipe residues of ink from the nozzles, and (iii) to a second side section of the nozzle plate. Note that the ribbon is moved along the short axis only when one of the second sections is facing the print bar and the nozzles are not jetting ink droplets. Moreover, the WA is configured to move the ribbon along the short axis sufficiently fast, so that the ribbon is moved away from the central section of the print head, before the next first section of the substrate is facing the print par and the nozzles are jetting the ink droplets toward the substrate.

In some embodiments, the processor is configured to schedule the frequency of the ribbon movement along the short axis of the print bar, while continuously moving the ribbon along the long axis of the print bar. In such embodiments, when the processor controls the WA to carry out the next wiping operation of the ink residues, the WA is configured to move the ribbon in the opposite direction along the short axis. In the present example, the opposite direction is specified from the second side section of the nozzle plate, over the nozzles of the central section, to the first side section of the nozzle plate. In other words, the processor is configured to control the WA to move the ribbon back and forth along the short axis of the print bar, at any suitable frequency, while continuously moving the ribbon along the long axis of the print bar.

In some embodiments, the wiping frequency may comprise any suitable discrete number of second sections, e.g., wiping every ten second sections, or a predefined time interval, e.g., performing ink wiping every one minute, or a combination thereof, or using any other suitable scheduling technique.

In some embodiments, the image forming station comprises multiple print bars for multiple colors of ink, respectively. For example, the system may comprise (i) a print bar (PB) for applying cyan ink, referred to herein as a cyan PB, and (ii) a print bar (PB) for applying magenta ink, referred to herein as a magenta PB. Each print bar comprises multiple (e.g., tens of thousands) nozzles configured to apply (e.g., by jetting or spraying) ink droplets of the respective color (e.g., cyan or magenta) to the first section of the substrate. Note that digital printing system is configured to apply any number of ink colors, e.g., four or seven different colors. The present example of two colors of ink is provided by way of example, for the sake of conceptual clarity.

In some embodiments, the substrate may comprise (i) a target substrate, such as a sheet or continuous web, configured to receive the droplets for producing the image directly from the image forming station, or (ii) a flexible intermediate transfer member (ITM), also referred to herein as a blanket, which is configured to receive the ink droplets for producing the image, and subsequently, to transfer the image to a target substrate. In the present example, the blanket has two ends and a seam section for coupling between the ends, so as to design the blanket in a loop shape. In some embodiments, when the blanket is moved in the moving direction and the aforementioned seam section (or any other second section) is facing a given print bar, the processor controls the given print bar to temporary stop applying the ink to the blanket. After the seam section passes the given print bar, the processor controls the given print bar to resume the application of ink to the blanket.

In some embodiments, each print bar comprises a separate WA having a ribbon. For example, the ribbon of a given WA is moved, inter alia, over the nozzle plate below a given print bar, in a gap between the given print bar and the substrate, at least in two directions as described above. The non-printable section may comprise, for example, a non-printable area between images on the blanket or on a continuous web, or between sheets in a direct printing system. Note that at the same time, the processor is configured to control at least one of the other print bars of the system, to apply ink droplets to the substrate while the ribbon is wiping ink residues from the given print bar, as described in detail above.

For example, when the seam section of the blanket passes below (i.e., facing) the cyan PB, the processor is configured to control a first WA to remove ink residues from the nozzles of the cyan PB, while at the same time, the nozzles of the magenta PB apply ink droplets to another section of the substrate. Subsequently, when the seam section of the blanket passes below the magenta PB, the processor is configured to control a second WA to remove ink residues from the nozzles of the magenta PB, while at the same time, the nozzles of the cyan PB apply ink droplets to the substrate. Note that the maintenance work of removing ink residues from the nozzles is carried out while the system is printing the image(s) on the blanket (i.e. on-the-fly).

In some embodiments, when the seam section passes below a given print bar, the processor is configured to control the wiping assembly to move the ribbon along the short axis of the print bar, for wiping the nozzles. As described above for the second sections, the wiping assembly is configured to move the ribbon along the short axis of the print bar sufficiently fast, so as to conclude the wiping of the nozzles before the seam section passes below the print bar.

In some embodiments, the ribbon is configured to carry out the wiping in a confined space between the print bar and the blanket, and has a self-supporting tense mechanism, also referred to herein as self-adhering or self-adhering force, for adhering to the nozzles while the ribbon is being moved by the wiping assembly. The self-adhering is configured, inter alia, to compensate for possible topographic differences among nozzles of different print heads of the print bar, as will be described in the detailed description below.

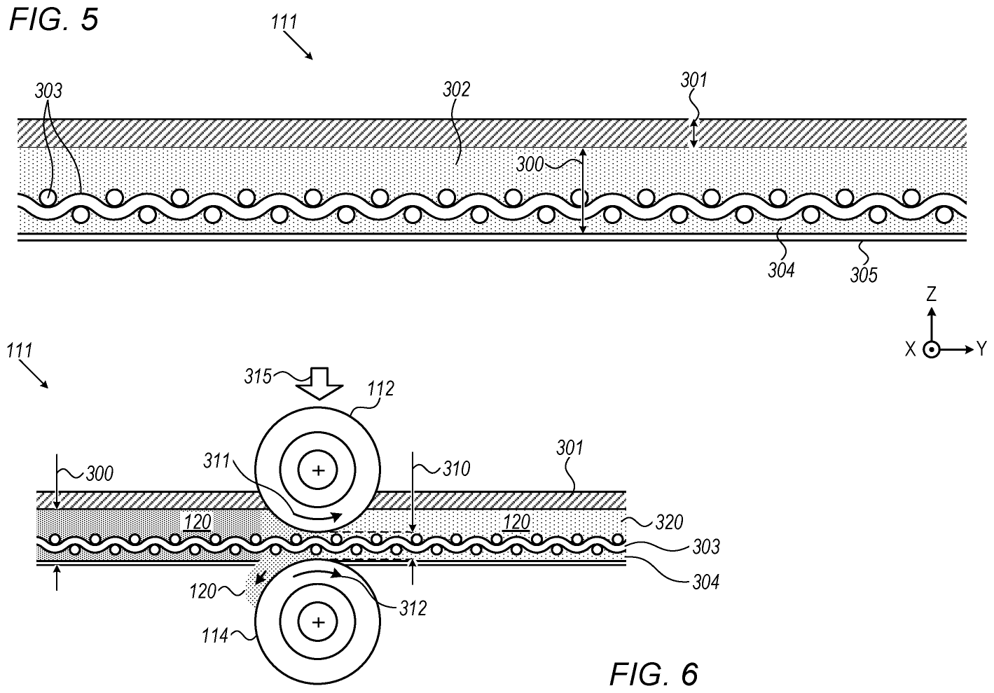

In some embodiments, the ribbon comprises a multilayered stack comprising: (i) a residues-removing layer, which is configured to be positioned over the nozzle plate of the print head while the ribbon is moved, and to wipe the residues from the nozzles, (ii) a compressible layer, having upper and lower surfaces; the upper surface is coupled to the residues-removing layer, and the compressible layer is configured to contain water for improving the adherence between the ribbon and the nozzles (and for another purpose described below), (iii) a core layer, which is implemented between the upper and lower surfaces of the compressible layer, and is configured to improve the dimensional stability of the ribbon in the presence of tension applied to the ribbon by the wiping assembly, and (iv) a polyethylene terephthalate (PET) layer, which is coupled to the lower surface of the compressible layer, and is configured to: improve the dimensional stability of the ribbon, seal the compressible layer to prevent leakage of water toward the blanket, and improve the flexibility of the ribbon for adhering to the nozzles of the print bar. The layers of the ribbon are described in more details, for example, in FIG. 5 of the present disclosure.

In some embodiments, the ribbon may be moved between (i) a supplying drum, configured to supply the clean ribbon for wiping the residues, and (ii) a receiving drum, configured to receive the ribbon after wiping the ink residues from the nozzles. This configuration, also referred to herein as a spool-to-spool configuration, requires replacement of the supplying drum when the entire clean ribbon is used.

In other embodiments, the ribbon may be moved in a closed loop between the print bar and a cleaning station, which is configured to remove the ink residues from the ribbon using any suitable technique. In the present example, the cleaning station comprises multiple water containers, each of which containing water and is coupled to a megasonic transducer, which is configured to vibrate the water within the container to assist in removing the ink residues from the ribbon. In some embodiments, the cleaning system may comprise a squeezing mechanism positioned between adjacent water containers, for squeezing from the ribbon at least a portion of the water with the residues and other contaminants contained in the ribbon. The cleaning station is also described in detail below.

In some embodiments, after the megasonic cleaning the ribbon is moved into a squeezing assembly for squeezing some of the water contained in the ribbon, and thereby, removing ink residues (and other sort of contamination) that may remain in the ribbon after the megasonic cleaning.

Note that a portion of the water remains within the compressible layer after the squeezing, so as to retain sufficient humidity in the ribbon to carry out several operations described below. In the context of the present disclosure and in the claims, the term squeezing refers to the operation of applying a compression force to the ribbon.

In some embodiments, the ribbon may be used for capping the orifices of the printing nozzles when the print bar is idle, and does not apply ink to the substrate. The humidity of the ribbon prevents coagulation of ink residues on the printing nozzles. Moreover, in both idle and printing positions of the system, the compressible layer is configured to absorb and contain vapors and aerosols of ink and contaminants hovering between the print bar and the blanket, so as to prevent solidification thereof on the nozzles of the print bar.

In some embodiments, the humidity of the ribbon is sufficient to carry out the wiping, and to enable the self-adhering of the ribbon, using the adhesion force between the water contained in the ribbon and the aforementioned nozzle plate of each print head of the print bar.

The disclosed techniques improve the printing quality of inkjet printing systems, by reducing the amount of defects and distortions caused by clogged the nozzles of the print bar. Moreover, the disclosed techniques improve the productivity inkjet-printing systems, by cleaning the nozzles on-the-fly, i.e., while the printing system continuously printing images on a substrate.

### System Description

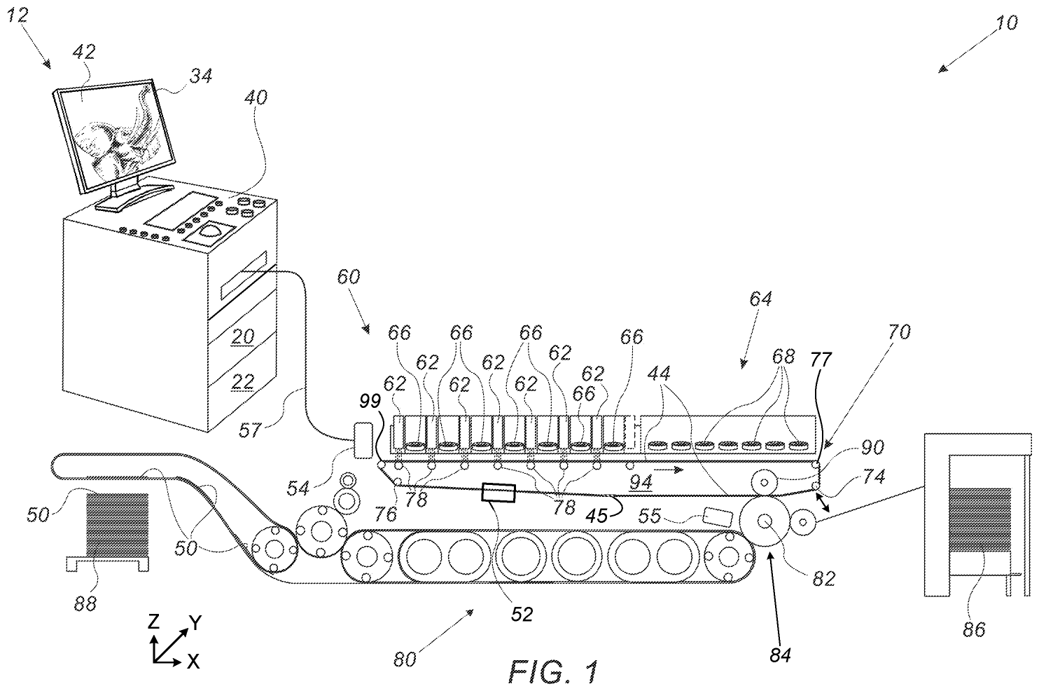

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered edge to edge, using a seam section 45, so to form a continuous blanket loop. An example of a method and a system for the installation of the seam is described in detail in U.S. Patent Application Publication 2020/0171813, whose disclosure is incorporated herein by reference.

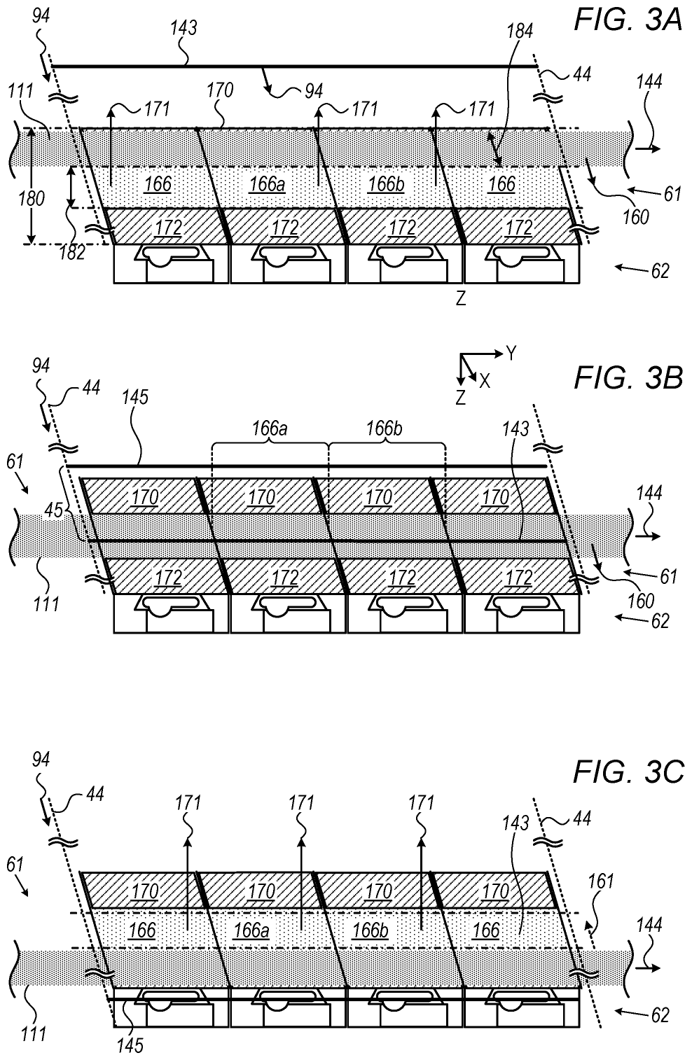

In some embodiments, image forming station 60 typically comprises multiple print bars 62, each mounted on a frame (not shown) positioned at a fixed height above the surface of the upper run of blanket 44. In some embodiments, each print bar 62 comprises a strip of print heads as wide as the printing area on blanket 44 and comprises individually controllable printing nozzles shown, for example, in FIGS. 3A and 3C below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44. In the present example, blanket 44 is moved along an X-axis of an XYZ coordinate system of system 10, and the ink droplets are directed by the print heads, typically parallel to a Z-axis of the coordinate system.

In some embodiments, different print bars 62 are spaced from one another along the movement axis, also referred to herein as (i) a moving direction 94 of blanket 44 or (ii) a printing direction. In the present example, the moving direction of blanket 44 is parallel to an X-axis, and each print bar 62 is extended along a Y-axis of system 10. In this configuration, accurate spacing between bars 62 along an X-axis, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” “color-to-color registration,” “C2C registration,” “color to color position difference,” “bar to bar registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the inkjet nozzles of the print heads, and/or (iii) in preventing the droplets of different color inks on blanket 44 from undesirably merging into one another.

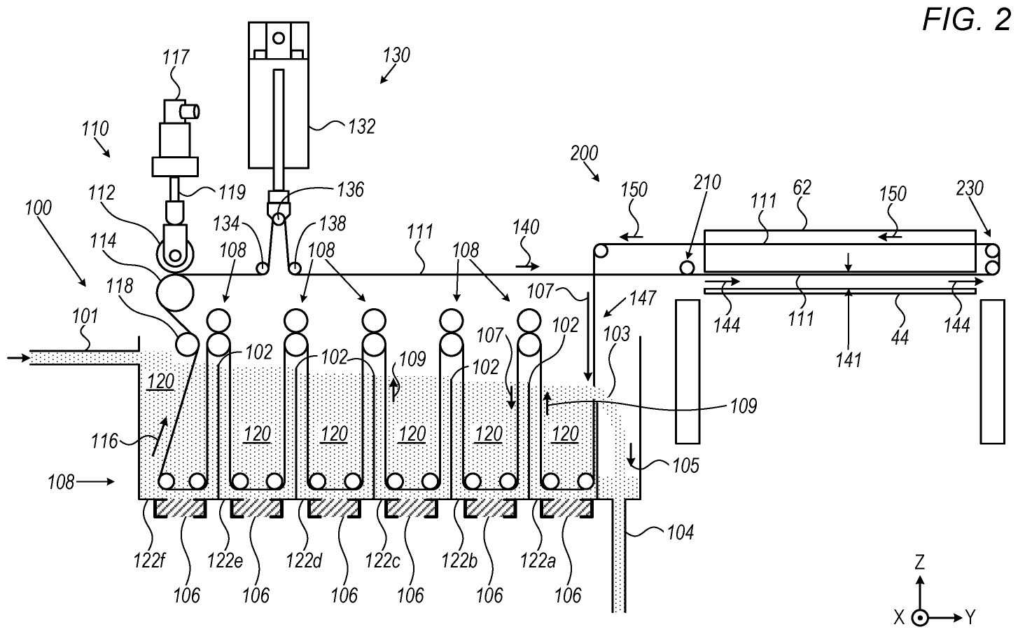

In some embodiments, system 10 comprises a wiping assembly, also referred to herein as a wiper, which is configured to remove residues of printing fluids that remain on the nozzles of each print bar 62, after applying the printing fluid to blanket 44. In such embodiments, each print bar 62 may have a separate wiping assembly for removing the residues of the printing fluids. Embodiments of the wiping assembly are shown and described in detail in FIGS. 2-7B below.

In some embodiments, system 10 comprises drying station 64, configured to direct infrared radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, blanket 44 may comprise an integrated encoder (not shown) for controlling the operation of various modules of system 10. One implementation of the integrated motion encoder is described in detail, for example, in PCT International Publication WO 2020/003088, whose disclosure is incorporated herein by reference.

In some embodiments, blanket 44 is guided over rollers 76, 78 and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74.

In impression station 84, blanket 44 passes between an impression cylinder 82 and a pressure cylinder 90, which is configured to carry a compressible blanket (not shown). In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may additionally or alternatively be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet, station 52 may be mounted adjacent to blanket 44 at any other or additional one or more suitable locations between impression station 84 and image forming station 60. As described above, station 52 may additionally or alternatively be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single-sided and double-sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

As briefly described above, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, station 55 may comprise a spectrophotometer (not shown) configured to monitor the quality of the ink printed on sheet 50.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing marks (not shown) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of thresholds, and (iii) output sheets 50 having minor distortions, e.g., below the second set of thresholds, to output stack 88.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configuration of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

### Controlling Cleanliness of Printing Nozzles Using a Wiping Assembly and a Cleaning Station Thereof

FIG. 2 is a schematic side view of a wiping assembly (WA) 200 and a cleaning station (CS) 100, in accordance with an embodiment of the present invention. In the context of the present disclosure and in the claims, the terms “WA 200,” “residues removal assembly” and “wiper 200” are used interchangeably, and refer to an assembly for removing residues of printing fluids remaining on the nozzles of print bars 62 after applying the printing fluids to blanket 44 or to any other substrate.

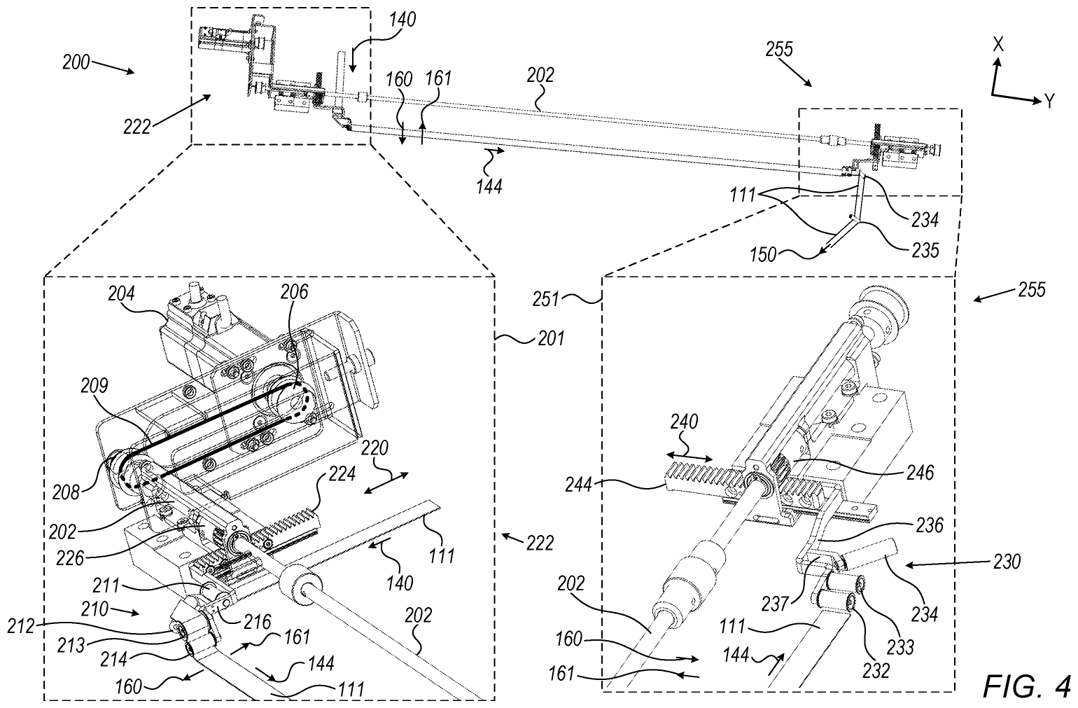

Note that, for the sake of presentation and conceptual clarity, WA 200 and CS 100 are not displayed in the same scale in FIG. 2. For example, based on the coordinate system of X, Y and Z axes shown in FIG. 2, the length of print bar 62 along the Y-axis, is about 1 meter, whereas the entire size of CS 100 is between about 30 cm and 70 cm. CS 100 is presented larger in FIG. 2 in order to be described in detail, and WA 200 is described in more detail in FIG. 4 below.

In some embodiments, system 10 comprises multiple WAs 200. In the present example, system 10 comprises a separate WA 200 for each print bar 62 shown in FIG. 1 above, but in other embodiments, system 10 may comprise any suitable number of wipers, each of which having any suitable configuration. For example, (i) a single wiping assembly may be used for cleaning the nozzles of all print bars 62 of system 10, or (ii) at least one print bar 62 may have multiple wipers.

In some embodiments, WA 200 comprises a ribbon 111, which is configured to be moved in a direction 144 (as described in detail below) within a gap 141 between print bar 62 and blanket 44. Ribbon 111 is moved in direction 144, so as to wipe residues of ink and other sorts of residues from the nozzles of print bar 62. Note that each print bar 62 of system 10 has a separate ribbon 111 for wiping the residues from the nozzles of the respective print bar 62.

In the present example, blanket 44 is moved in moving direction 94 (shown in FIG. 1 above), which is parallel to the X-axis of system 10. In some embodiments, ribbon 111 is moved in direction 144, which is typically parallel to the Y-axis of system 10, and is also moved in an additional direction, parallel to an X-axis, as will be described in detail in FIGS. 3A, 3B and 3C below. In other words, at a first-time interval, ribbon 111 is moved along one axis (e.g., Y-axis), and at a second different time interval, ribbon 111 is moved simultaneously along two axes (e.g., X-axis and Y-axis). Moreover, WA 200 is configured to move ribbon 111 (i) along the Y-axis (which is also parallel to the long axis of print bar 62, and is orthogonal to moving direction 94 of blanket 44) using a continuous motion profile, and (ii) along the X-axis (which is also parallel to both the short axis of print bar 62 and moving direction 94 of blanket 44) using a discrete motion profile. Embodiments related to the aforementioned motion profiles are described in detail in FIGS. 3A-3C below. In other embodiments, ribbon 111 may be moved separately in the first direction and in the second direction, or simultaneously in the first and second directions.

In some embodiments, after a given section of ribbon 111 is wiping the residues off the nozzles, the given section of ribbon 111 is diverted by one or more reciprocating pulleys 230 (described in detail in FIG. 4 below) for being moved in a direction 150, and for being inserted into CS 100 for removing the residues. Subsequently, the given section of ribbon 111, which has been cleaned from the residues in CS 100, is moved in a direction 140, and subsequently, the given section of ribbon 111 is diverted by one or more reciprocating pulleys 210 (described in detail in FIG. 4 below) for being inserted between blanket 44 and print bar 62. Subsequently, WA 200 repeats the wiping of residues from the nozzles by moving in direction 144 (which is typically but not necessarily parallel to Y-axis) and in parallel to the X-axis (which is typically but not necessarily parallel to the movement direction of blanket 44), simultaneously, followed by moving ribbon 111 for cleaning, as described above.

In some embodiments, the above-described cycle of residues-wiping and ribbon-cleaning may be repeated during the printing cycle, without stopping the printing operation, i.e., on-the-fly. In some cases, after applying (e.g., jetting) the printing fluids from the nozzles of print bar 62, residues of the printing fluids may remain on the surface of a given nozzle and coagulate to produce an undesired cluster. The cluster may (i) partially clog an opening of the nozzle, which may result in a C2C registration error, caused by interference in the steering angle of the subsequent printing fluids being jetted from the given nozzle toward blanket 44, or (ii) fully clogging (i.e., fully blocking) the nozzles, which may cause, for example, missing ink at one or more positions on the image, or (iii) formation of an undesired defect, such as a particle, when the cluster is jetted toward or falling on the printed image.

In some embodiments, ribbon 111, which is described in detail in FIG. 5 below, is configured to remove and collect the residues from the nozzles of print bar 62, and to release the collected residues in CS 100, as will be described herein.

In some embodiments, cleaning station (CS) 100 comprises multiple containers of a suitable cleaning fluid. In the present example, five or more water containers (WCs) 122, referred to herein as WCs 122a, 122b, 122c, 122d, 122e and 122f, are configured to contain any suitable type of water 120, such as but not limited to deionized water.

In some embodiments, CS 100 is configured to carry out an acoustic-based removal (also referred to herein as acoustic cleaning) of the residues from ribbon 111. In the present example, CS 100 comprises five or more (e.g., six) megasonic transducers (MTs) 106 coupled, respectively, to five or more (e.g., six) WCs 122a-122f, and to one or more generators (not shown). Each MT 106 is configured to produce, within water 120 contained in the respective WC, an acoustic field having a suitable frequency, e.g., between about 0.6 NHz and 5 MHz, and in particular about 1.6 MHz. In some embodiments, MTs 106 of CS 100 may comprise any suitable type of transducers. Note that MTs 106, or any other sort of ultrasonic or megasonic transducers, are configured to agitate water 120 so as to help remove contaminants, such as pigments or other residues, from ribbon 111. In other embodiments, CS 100 may comprise, instead of or in addition to the aforementioned transducers, any other suitable sort of agitator(s) for removing the wiped residues and other contaminants from ribbon 111. In alternative embodiments, the residues and other contaminants may be removed from ribbon 111 by squeezing ribbon 111 when passing between rollers 108 described below.

In some embodiments, CS 100 comprises a water inlet pipe 101, which is configured to fill WC 122f with clean water 120, and a water-drain pipe 104, which is configured to receive water 120 typically contaminated with the aforementioned residues, away from WC 122a of CS 100. In the context of the present disclosure and in the claims, the term “clean” refers to a water container having a small amount of residues in water 120, and the term “dirty” refers to a water container having a larger amount of residues in water 120.

In the configuration shown in FIG. 2, WCs 122 are arranged in steps, such that water 120 is flowing from WC 122f, through all WCs 122, to WC 122a, and then spilled over to water-drain pipe 104. For example, when filling WC 122f, water 120 spills-over, at a spilling point 102, to WC 122e. Similarly, when filling WC 122a, which is the last water container, water 120 spills-over, through a spilling point 103, in a direction 105 toward water-drain pipe 104.

In some embodiments, CS 100 comprises a conveyor 147 having multiple rollers 108, which are positioned within WCs 122 and out of WCs 122, and are configured to convey ribbon 111 through WCs 122 of CS 100. Note that each pair of rollers 108 is also configured to squeeze water 120, which are soaked in ribbon 111 and contain the residues and other contaminants described above. In the present example, a given section of ribbon 111 that carries the residues wiped from the nozzles is moved in a direction 107 for being inserted into WC 122a, which has more residues than any other WC 122 of CS 100. After having a first acoustic cleaning within WC 122a, the given section is moved in a direction 109 for exiting WC 122a, via a pair of rollers 108, and moved again in direction 107, into WC 122b. Note that the amount of residues in WC 122b is typically lower compared to that in WC 122a, because (i) WC 122a receives ribbon 111 with residues wiped directly from the nozzles of print bar 62, and (ii) WC 122b receives a flow of water from WC 122c, which typically contain less residues compared to WC 122b. Moreover, when entering WC 122b, ribbon 111 has less residues compared to the amount of residues when entering WC 122a, because some of the residues have been removed by WC 122a.

In some embodiments, processor 20 and/or controller 54 are configured to control the speed of ribbon 111, for example, in direction 144 and in directions 107 and 109. The speed of ribbon 111 in directions 107 and 109 controls the amount of water 120 absorbed by ribbon 111, and the speed of ribbon 111 in direction 144 (and another direction shown in FIGS. 3A and 3B below), controls the time a given section of ribbon 111 is touching a given nozzle for the wiping process.

In some embodiments, ribbon 111 is moved through CWs 122c, 122d, 122e and 122f for additional acoustic cleaning, and subsequently, retracted from WC 122f in a direction 116. Based on the principles described above, WC 122f is the cleanest water container, from among CWs 122, which receives clean water from water inlet pipe 101, and WC 122a is the dirtiest water container, from among CWs 122, whose water 120 are spilled into drain water-drain pipe 104. Therefore, CS 100 is configured to remove from ribbon 111, the residues wiped from the nozzles.

In some embodiments, after being pulled in direction 116, out of WC 122f, ribbon 111 is diverted by a roller 118 and moved into a squeezing assembly 110, which is configured to squeeze a large portion of water 120 remaining within ribbon 111. In some embodiments, squeezing assembly 110 comprises rotatable drums 112 and 114, configured to rotate about their own axes for the squeezing operation, which is briefly described above and is further described in detail in FIG. 6 below.

In some embodiments, squeezing assembly 110 further comprises a controllable piston 117 and a shaft 119, which are configured to control the amount of water 120 squeezed out of ribbon 111 by controlling the distance between drums 112 and 114. In such embodiments, a smaller distance between drums 112 and 114 reduces the amount of water 120 remaining within ribbon 111 after the squeezing process.

In other embodiments, CS 100 may comprise any other suitable type of one or more cleaning fluids, instead of or in addition to water 120.

In other embodiments, squeezing assembly 110 may comprise, instead of piston 117 and shaft 119, any other suitable technique for controlling the level of squeezing.

In some embodiments, cleaning station 100 comprises a tension assembly (TA) 130, which is configured to apply tension to ribbon 111 for retaining ribbon 111 taut, at least during the squeezing process and when ribbon 111 is moved in direction 140 toward reciprocating pulleys 210 as described above. In the present example, TA 130 comprises a controllable piston 132 and rollers 134, 136 and 138. Piston 132 is configured to move along Z-axis, and thereby, to control the position roller 136 along Z-axis for applying the specified tension to ribbon 111. For example, in case ribbon 111 is not sufficiently taut, piston 132 moves along the Z-axis for increasing the distance between (i) roller 136 and (ii) rollers 134 and 138, and thereby, increasing the tension applied to ribbon 111 and causing ribbon 111 to be sufficiently taut.

In some embodiments, TA 130 is configured to control the tension applied to ribbon 111 during the entire cycle of residues wiping (within WA 200) and residues cleaning (within CS 100).

In other embodiments, TA 130 may comprise, instead of or in addition to at least piston 132 and roller 136, a spring (not shown) or any other suitable mechanism for controlling the tension applied to ribbon 111. Additionally, or alternatively, at least one of system 10, WA 200 and CS 100, may comprise one or more tension assemblies for controlling the tautness level of ribbon 111 along the cycle described above.

In some embodiments, cleaning station 100 and assemblies 110 and 130 are controlled by processor 20 and/or by controller 54 of system 10. In other embodiments, one or more of cleaning station 100 and assemblies 110 and 130 may be controlled by one or more controllers (not shown) e.g., of CS 100, which are controlled by processor 20 and/or by controller 54.

In alternative embodiments, instead of cleaning the residues from ribbon 111 using a closed loop as described above, WA 200 may comprise two drums (not shown). A first drum supplies a clean ribbon 111 for wiping the residues from print bar 62, and a second drum, for receiving ribbon 111 after wiping the residues from print bar 62. This configuration is also referred to herein as spool to spool. Note that the clean ribbon may be moved through a reservoir of cleaning fluids, such as water 120, and a squeezing assembly (e.g., squeezing assembly 110) for containing a predefined amount of water 120 within compressible layer 300 of ribbon 111. As described in FIGS. 2 and 5 above, the water contained within compressible layer 300 may be used for adhering ribbon 111 to all the nozzles of print bar 62, and for removing the residues from the nozzles.

FIGS. 3A, 3B and 3C are schematic pictorial illustrations of ribbon 111 moved relative to bottom surfaces of sections 170 and 172 of nozzle plates 61 of respective print heads of print bar 62, in accordance with an embodiment of the present invention. Each print head of print bar 62 has a nozzle plate 61 comprising sections 170 and 172, and an array of nozzles described in detail below.

Note that FIGS. 3A, 3B and 3C show a bottom-view of print bar 62 and a sequence showing the positions of seam section 45 of blanket 44 and ribbon 111 moving relative to print bar 62.

In some embodiments, the operation of WA 200, and particularly, the movement of ribbon 111 is synchronized with the jetting and non-jetting time intervals of the respective print bar 62 of system 10. In such embodiments, when a given print bar 62 is jetting (through the nozzles) printing fluids (e.g., ink) to blanket 44, the ribbon is not wiping these nozzles. However, in non-jetting time intervals, a given WA 200 of a given print bar 62, is configured to move a given ribbon 111 thereof, for wiping the nozzles of the given print bar 62.

The embodiments of FIGS. 3A-3C below describe how the movement of ribbon 111 is controlled based on the position of seam section 45. In other words, the wiping of the nozzles of print bar 62 is carried out during a non-jetting time interval, e.g., when seam section 45 of blanket 44 passes adjacent to (e.g., below) print bar 62 so that the nozzles of the print bar are not jetting printing fluids toward blanket 44. Note that the same techniques are also applicable when other sections of blanket 44 pass below print bar 62. For example, when a section of blanket 44, which is located between two sections designated for receiving droplets of ink for producing images thereon (for example between images of two sheets), passes below print bar 62, the nozzles are not jetting printing fluids, and at the same time, ribbon 111 may be used for wiping these nozzles.

Reference is now made to FIGS. 3A-3C, which illustrate snapshots of blanket 44 with seam section 45, schematically defined between solid lines 143 and 145, being moved relative to print bar 62.

In FIG. 3A seam section 45 has not yet reached print bar 62, in FIG. 3B seam section 45 has reached print bar 62 and faces nozzles 166, 166a and 166b, and in FIG. 3C, seam section 45 has already passed print bar 62 and continues toward other print bars 62 and/or drying station 64.

In some embodiments, print bar 62 comprises multiple print heads shown as arrays of nozzles 166, 166a and 166b, and sections 170 and 172. In the present example, sections 170 and 172 are typically made from a ceramic material, positioned at the sides (e.g., edges) of nozzles 166, and are approximately flush with nozzles 166, 166a and 166b. Moreover, typically sections 170 and 172 do not have nozzles, and therefore, are not configured for jetting the printing fluids.

In the example of FIG. 3A, nozzles 166, 166a and 166b apply the printing fluids (e.g., droplets of ink) to blanket 44 in a direction 171, typically orthogonal to the blanket movement direction, and parallel to the Z-axis. At the same time, blanket 44, shown in dashed lines, is moved in moving direction 94 (parallel to the X-axis), and ribbon 111 is moved in direction 144, which is parallel to the Y-axis.

In some embodiments, print bar 62 has a width 180, which is between about 40 mm and 42 mm, and the arrays of nozzles 166, 166a and 166b have a width 182, which is between about 12 mm and 14 mm. Based on widths 180 and 182, sections 170 and 172 have, each, a width between about 13 mm and 15 mm.

In some embodiments, ribbon 111 has a width 184 between about 12 mm and 14 mm, which is approximately similar to width 182 and slightly smaller than the width of sections 170 and 172. Note that, in such embodiments, when moving in direction 144, ribbon 111 is not positioned between (i) nozzles 166, 166a and 166b and (ii) blanket 44, and therefore, does not block printing fluids that are jetted, in direction 171, from nozzles 166, 166a and 166b toward the surface of blanket 44.

During the operation of system 10, e.g., during the printing process, a solid line 143 passes adjacent to print bar 62. Solid line 143 is indicative of a first edge of seam section 45, which is an integral part of blanket 44 and is therefore moved with blanket 44 toward print bar 62. In some embodiments, when the first edge of seam section 45 is at a preassigned distance from nozzles 166, 166a and 166b, processor 20 is configured to control WA 200 to move ribbon 111 in a direction 160, which is typically parallel to the X-axis. In the context of the present disclosure and in the claims, direction 160 is parallel to the moving direction of blanket 44, also referred to herein as the printing direction, and direction 144, which is orthogonal to the printing direction, is also referred to herein as a cross-printing direction. Moreover, print bar 62 has (i) a long axis, which is parallel to Y-axis and direction 144, and (ii) a short axis, which is parallel to X-axis and direction 160. Therefore, in some embodiments, WA 200 is configured to move ribbon 111 substantially parallel to the long axis of print bar 62 (i.e., in direction 144), and also substantially parallel to the short axis of print bar 62 (i.e., in direction 160).

In some embodiments, the preassigned distance is determined by processor 20, based on the moving speed of blanket 44 and other parameters of system 10. Note that in such embodiments, WA 200 moves ribbon 111 simultaneously in directions 144 and 160. In the present example, the moving speed of ribbon 111 in direction 144 is between about 1 mm/sec and 20 mm/sec, whereas the moving speed of ribbon 111 in direction 160 is substantially higher, e.g., at any suitable speed larger than 750 mm/sec.

Note that widths 180, 182 and 184, the structure of print bar 62 and ribbon 111, and the speed of ribbon 111 in directions 144 and 160, are all provided by way of example and may vary. In other embodiments, at least one of print bar 62 and ribbon 111 may have any other suitable structure and/or width, and WA 200 may move ribbon 111 in a different speed in at least one of directions 144 and 160. Moreover, in the present example directions 144 and 160 are orthogonal to one another, but in other embodiments, directions 144 and 160 may have any other suitable angle therebetween.

In alternative embodiments, system 10 may comprise, instead of or in addition to ribbon 111, any other suitable type of wiping element or any other suitable sort of residues removal assembly for removing the residues of the printing fluids from nozzles 166, 166a and 166b, for example, sprayers of suitable cleaning fluids or any other contact or non-contact cleaning devices.

In the example of FIGS. 3A-3C print bar 62 comprises multiple arrays of nozzles 166, 166a and 166b and sections 170 and 172 arranged in multiple print heads along the Y-axis and across the X-axis. In other embodiments, nozzles 166, 166a and 166b and sections 170 and 172 may be arranged using any suitable configuration other than in multiple print heads, for example, print bar 62 may comprise a single print head having the length of print bar 62 (e.g., about 1 meter).

Reference is now made to FIG. 3B showing a time interval in which seam section 45 of blanket 44 is aligned, in the Z-axis, with the arrays of nozzles 166, 166a and 166b. In other words, seam section 45 passes adjacent to the arrays of nozzles 166, 166a and 166b, in the present example at a distance of gap 141 (e.g., between about 1 mm and 2 mm), and faces the arrays of nozzles 166, 166a and 166b.

In some cases, at least two of the print heads of print bar 62 may not be completely flush, e.g., in the Z-axis, with one another. For example, the plate comprising the arrays of nozzles 166a may be positioned, along the Z-axis, about 0.05 mm higher than the plate comprising the arrays of nozzles 166b. In such cases, when a given ribbon (different from ribbon 111) is moved in direction 144, the sufficiently taut given ribbon may hover without touching nozzles 166b, and therefore, residues of printing fluids may not be wiped by ribbon 111 from at least some of nozzles 166b.

In some embodiments, ribbon 111 is configured to have a self-adhering force, which is described in detail in FIG. 5 below and is also referred to herein as a self-supporting tense mechanism, so as to produce contact with all the nozzles of all the print heads of print bar 62. Note that

In some embodiments, when being moved in directions 144 and 160, ribbon 111 is configured to be sufficiently taut, so as to fit-in within the confined space between blanket 44 and the print heads of print bar 62. Yet, based on the self-adhering force, ribbon 111 is configured to adhere (i.e., produce contact) and wipe the residues from all the nozzles (e.g., nozzles 166, 166a and 166b) of print bar 62. Note that, when being moved in at least one of directions 144 and 160, one or more forces (e.g., tension forces) are applied to ribbon 111 in an XY plane (e.g., along X-axis and Y-axis). In some embodiments, based on the self-adhering force, ribbon 111 is configured to adhere to the surface of nozzle plate 61 without any force applied, along the Z-axis, to ribbon 111 or to print bar 62. In other words, while a lateral tension force is applied to the ribbon along X-axis and/or Y-axis, ribbon 111 is configured to adhere to the nozzle plate of print bar 62 without any vertical force applied to the ribbon and/or the print bar. As described above, the adherence mechanism in Z-axis is also referred to herein as self-adherence force or self-supporting force of the ribbon to the nozzle plate of the print heads of print bar 62. Moreover, the amount of and type of fluid (e.g., water 120) contained within compressible layer 300, may be used for improving the adherence of ribbon 111 to all the nozzles of print bar 62, and for removing the residues off the nozzles, also referred to herein as wiping.

In some embodiments, based on the self-adhering force, ribbon 111 is configured to compensate for topographic differences between different nozzles of print bar 62, and to adhere to each nozzle of print bar 62 for removing residues therefrom. In some embodiments, the adhering mechanism is enabled by the multi-layered structure of ribbon 111, described in detail in FIG. 5 below.

In some embodiments, during the printing operation, the distance (e.g., gap 141) between blanket 44 (that is taut and moves in the moving direction) and print bar 62 is typically between about 1 mm and 1.5 mm, but in other embodiments, gap 141 may be larger or smaller than the aforementioned range. Moreover, ribbon 111 has a thickness of about 0.1 mm and is typically in physical contact with: (i) section 170 (as shown in FIG. 3A), or (ii) nozzles 166, 166a and 166b (as shown in FIG. 3B), or (iii) section 172 (as shown in FIG. 3C), and positioned between print bar 62 and blanket 44.

As described in FIG. 2 above, ribbon 111 is moved within gap 141, such that the thickness of ribbon 111 is substantially smaller (e.g., between about 5× and 15×) compared to gap 141. Moreover, as described in FIG. 3A above, width 184 of ribbon 111 is sized so that when ribbon 111 is moved only in direction 144, the ribbon or any section thereof is not covering the nozzles. Furthermore, as described above, width 182 of the arrays of nozzles 166, 166a and 166b is sufficiently small (e.g., about 12.9 mm) and the movement speed of ribbon 111 in direction 160 is sufficiently fast (e.g., about 8 meters per second), so as to conclude the wiping of the nozzles within about 50 msec, which is typically shorter than the time interval in which seam section 45 passes below the nozzles of print bar 62.

In some embodiments, WA 200 moves ribbon 111 between sections 170 and 172, and when seam section 45 is facing print bar 62, nozzles 166 do not jet printing fluids toward blanket 44, and ribbon 111 wipes residues of the printing fluids from nozzles 166.

In some embodiments, ribbon 111 covers one or more nozzles 166 when at least a section of seam section 45 is facing one or more of nozzles 166 for removing residues of the printing fluid. As shown in FIG. 3B, when seam section 45 is fully facing width 182, the entire width 182 of ribbon 111 is positioned over nozzles 166. Note that when seam section 45 is approaching print bar 62 (as shown in FIG. 3A) and facing print bar 62 (as shown in FIG. 3B), WA 200 is configured to move ribbon 111 in both directions 144 and 160.

In some embodiments, processor 20 and/or controller 54 are configured to control the movement direction and speed of ribbon 111, for example, in directions 144 and 160. The speed of ribbon 111 in directions 144 and 160 controls the time a given section of ribbon 111 is touching a given nozzle of print bar 62 for the wiping process.

Reference is now made to FIG. 3C, showing the position of ribbon 111 relative to print bar 62 and seam section 45. In some embodiments, after seam section 45 of blanket 44 passes print bar 62 and continues moving toward other print bars 62 and/or drying station 64, WA 200 has completed the wiping of nozzles 166 and moved ribbon 111 to section 170 of print bar 62. As shown in FIG. 3C, solid line 145, which is indicative of the second, rear end, of seam section 45, moves in the moving direction and is not facing print bar 62 anymore. In some embodiments, image forming station 60 resumes the jetting of printing fluids in direction 171 from nozzles 166 toward blanket 44 for forming the next image on blanket 44.

In some embodiments, the time interval shown in FIGS. 3A-3C, when ribbon 111 is moved from section 170, via nozzles 166, to section 172, is between about 20 milliseconds (msec) and 300 msec. For example, when the blanket is moved in moving direction 94 at a speed between about 2.5 and 4 meters/second, the time interval for moving ribbon 111 between sections 170 and 172 is about 50 msec.

In some embodiments, WA 200 is configured to move ribbon 111 during the operational time of system 10 while system 10 jets droplets of printing fluids and forms images on blanket 44 (i.e., on-the-flight). Moreover, blanket 44 is moved for receiving the images from image forming station 60, while ribbon 111 is wiping the residues from nozzles 166. In such embodiments, WA 200 of system 10 is configured to clean the residues while system 10 continues the printing operation.

In principle, it is possible to hold the printing operation of system 10, and perform the residues wiping in a maintenance mode. However, the maintenance mode reduces the productivity or system 10, which is not printing during the maintenance. In some embodiments, based on the disclosed techniques, the maintenance operations (e.g., removing the residues of printing fluids from nozzles 166) are carried out on-the-fly, while system 10 is printing images on blanket 44.

In some embodiments, after seam section 45 passes print bar 62, WA 200 continues to move ribbon 111 solely in direction 144, and when seam section 45 is approaching print bar 62 again (after completing the cycle of blanket 44 shown in FIG. 1 above), WA 200 is configured to move ribbon 111 in a direction 161, which is opposite to direction 160, so as to wipe nozzles 166, 166a and 166b of print bar 62. In the example of FIG. 3C, the arrow showing direction 161 is dashed for illustrating that ribbon 111 is moved in direction 161 only when seam section 45 is approaching print bar 62, as described above. Note that in such embodiments, ribbon 111 is moved in a reversed order, i.e., from FIG. 3C to FIG. 3A, so that the ribbon is moved in direction 144 and in direction 161. In other words, WA 200 is configured to move ribbon 111 in directions 144 and 160. Direction 144 is parallel to a long axis of print bar, and direction 160 is parallel to a short axis of print bar 62. In the present example, residues removal is scheduled every time seam section 45 passes adjacent to print bar 62, also referred to herein as a cycle of blanket 44. In this example, (i) when seam section 45 is not adjacent to print bar 62, ribbon 111 is moved only in direction 144, and (ii) when seam section 45 passes adjacent to print bar 62, ribbon 111 is moved in both directions 144 and 160. Thus, ribbon 111 is moved back and forth between sections 170 and 172, and completes one back and forth movement in two cycles of blanket 44.

In some embodiments, WA 200 is configured to apply different motion profiles when moving ribbon 111 in directions 144 and 160, for example, a continuous motion profile and a discrete motion profile. In the context of the present disclosure and in the claims, the term “continuous motion” refers to a non-stop motion at a predefined speed, and the term “discrete motion” refers to a movement that occurs only at predefined time intervals, which are typically recurring at a predefined frequency, but not necessarily.

In the continuous motion profile WA 200 moves ribbon 111 at a relatively low speed (e.g., lower than about 20 mm/sec) in direction 144. In the discrete motion profile WA 200 moves ribbon 111 at a relatively high-speed (e.g., higher than about 750 mm/sec) in direction 160. As described above, both motion profiles may be carried out simultaneously or separately.

In some cases, blanket 44 may have a temperature of about 80 degrees Celsius and nozzles 166, 166a and 166b may have a lower temperature, e.g., between about 30 degrees Celsius and 35 degrees Celsius. In such cases, printing fluids and other substances may evaporate from blanket 44 and condensate on one or more of nozzles 166, 166a and 166b and subsequently solidify, and may at least partially clog one or more orifices of nozzles 166, 166a and 166b.

In some embodiments, ribbon 111 may be used for capping nozzles 166, 166a and 166b when image forming station 60 is in its non-operating mode or maintenance, e.g., not applying droplets to blanket 44. In such embodiments, WA 200 is configured to position ribbon 111 to cover nozzles 166, 166a and 166b, as shown in FIG. 3B, so that ribbon 111 blocks vapors and/or aerosols of the printing fluids and other materials from adhering to nozzles 166, 166a and 166b of print bar 62. In some embodiments, processor 20 and/or controller 54 are configured to control WA 200 to move (at any suitable speed) in direction 144 for continuously wiping the nozzles. In other embodiments, processor 20 and/or controller 54 are configured to control WA 200 to place ribbon 111 in contact with the nozzles and to hold ribbon 111 without moving in directions 144 and/or 160 for protecting the nozzles from being contaminated by vapors or aerosols when image forming station 60 is not applying the droplets of printing fluids to blanket 44.

Note that the presence of water 120 within ribbon 111 increases the humidity between ribbon 111 and nozzles 166, 166a and 166b, thereby preventing solidification of the residues of printing fluids on the nozzles. This mechanism is valid in both cases, (i) when ribbon 111 is moving (e.g., in directions 144 and/or 160 and touching the nozzles of print bar 62, and (ii) when ribbon 111 is standing still and touching the nozzles of print bar 62. In other words, the humidity of ribbon 111 prevents the solidification of the printing fluids on the nozzles.

In some embodiments, frequent wiping of the nozzles of each print bar 62 of system 10, e.g., every 10 seconds, or every 1 minute, or every 2 minutes, helps to maintain the specified functionality of the nozzles, and reduces the frequency of maintenance operations in which system 10 is not printing images. The inventors found that using the disclosed techniques, substantially reduces the amount of defects in the printed images. For example, when using WA 200 and applying the disclosed techniques, the number of missing nozzles and total blocked nozzles (when an orifice of a nozzle is completely clogged) and the amount of deviating nozzles (when an orifice of a nozzle is partially clogged) may be reduced over time by one or two orders of magnitude.

In the context of the present disclosure and in the claims, the terms “blocked” and “clogged” are used interchangeably, and the term “orifice of a nozzle” and “a nozzle” are used interchangeably.

In other embodiments, the techniques described in the present disclosure may be applied, mutatis mutandis, to direct printing systems. For example, when jetting ink or other printing fluids directly on a sheet or any other suitable substrate, ribbon 111 may be used for cleaning residues from printing nozzles between the printing of (i) a first image on a first sheet, and (ii) a second (similar or different) image on a second, subsequent, sheet.

In some embodiments, wiping of the nozzles of system 10 may be carried out at any suitable frequency and may be scheduled every predefined number of images and/or sheets, or based on a predefined time interval (e.g., every a predefined number of minutes), or using any other suitable criterion for defining of wiping frequency. In other words, when printing an image sequentially on multiple sheets, after printing the image on a first sheet, the printing system may use a short time interval for wiping the nozzles before starting to print the image on a second sheet that follows the first sheet. Moreover, the same techniques may be used when printing images sequentially on a continuous substrate, such as a web. In such processes, the nozzle-cleaning (e.g., wiping of ink residues) may be carried out when a portion or a section of the web between two consecutive images (one already printed and the next image to be printed) is positioned in close proximity to the printing nozzles. For example, when a section of the continuous substrate between two consecutive images passes below the nozzles.

As described above, the cleaning frequency may be carried out after every image or after every selected number of images. Note that also in both direct-printing cases described above (printing on separate sheets, or on a continuous substrate), the wiping of nozzles is carried out during the printing process, does not require to stop the operation of the printing system and does not reduce the printing output of the (direct) printing system. Moreover, the same techniques may be used for wiping residues from print heads in other types of indirect printing systems, for example, instead of or in addition to blanket 44, a printing system may comprise a drum that transfers one or more images to a target substrate.

FIG. 4 is a schematic pictorial illustration of wiping assembly (WA) 200, in accordance with an embodiment of the present invention. In some embodiments, WA 200 comprises a mechanical assembly (MA) 222, which is configured to move ribbon 111 in direction 140 from tension assembly (TA) 130, as shown in FIG. 2 above. MA 222 is further configured to divert ribbon 111 for wiping nozzles 166, 166a and 166b, and sections 170 and 172 of print bar 62, as shown in FIGS. 3A-3C above.

In some embodiments, WA 200 further comprises a mechanical assembly (MA) 255, which is configured, together with MA 222, to move ribbon 111 for wiping the aforementioned nozzles and surfaces of print bar 62. WA 255 is further configured to divert ribbon 111 in direction 150 toward cleaning station (CS) 100, as shown in FIG. 2 above. MAs 222 and 255 are described in detail below, in insets 201 and 251, respectively.

In some embodiments, WA 200 comprises a shaft 202, which is coupling between MAs 222 and 255 and is configured to rotate clockwise (CW) and counterclockwise (CCW) for moving the ribbon back and forth in directions 160 and 161 as described in FIGS. 3A-3C above. Note that WA 200 is configured to move ribbon 111: (i) in direction 144 in a first-time interval, which is typically performed at least as long as image forming assembly 60 is applying the droplets of printing fluids to blanket 44 (when ribbon 111 is positioned over sections 170 and 172). and (ii) in directions 160 and 161, alternately, in a second shorter time interval (e.g., about 50 msec in each direction 160 and 161) for wiping the residues of printing fluids from nozzles 166, 166a and 166b when ribbon 111 passes between sections 170 and 172. For example, the length of ribbon 111 may be between about 2 meters and 4 meters, and the moving speed in direction 144 may be about 10 mm/sec or between about 1 mm/sec and 20 mm/sec as described above. The second-time interval is about 50 msec and the moving speed of ribbon 111 in direction 160 is between about 800 mm/sec and 900 mm/sec. Therefore, a ratio between the first-time interval and the second time intervals may vary and may depend, inter alia, on the frequency of the wiping (defined by the number of images), the length and speed of ribbon 111 and other parameters.

In some embodiments, the ratio between the movement speed of ribbon 111 in directions 160 and 144 (also referred to herein as speed ratio) may be between about 8 (e.g., 800/100) and 900 (e.g., 900/1). In other embodiments, ribbon 111 may be moved using any other suitable speed ratio between about 5 and 10000.

In one implementation of the disclosed techniques, the wiping of the nozzles is carried out only when the seam section is passing image forming station 60. In this implementation, ribbon 111 is moved in direction 160 in one cycle of blanket 44 (shown in FIG. 1 above), subsequently, ribbon 111 is moved in opposite direction 161 in the following cycle of blanket 44, and this alternating cycle recurs as long as image forming station 60 is operative (e.g., continues to apply droplets on the moving blanket 44. Moreover, in such embodiments, the first-time interval overlaps with one or more second-time intervals, typically more than one.

Reference is now made to inset 201 showing the structure of MA 222 in detail. In some embodiments, MA 222 comprises a motor 204, typically a servo brushless motor or any other suitable motor, which is configured to rotate a belt 209 between pulleys 206 and 208 for rotating shaft 202.

In some embodiments, MA 222 comprises a gear 226 and a track 224, both comprising respective jagged structures that intertwine with one another. Gear 226 is configured to rotate together with shaft 202 for moving track 224 in a linear motion back and forth in directions 220, typically parallel to direction 140 and, in the present example, also parallel to directions 160 and 161. Note that when shaft 202 and gear 226 rotate clockwise, track 224 is moving in direction 140, and when shaft 202 and gear 226 rotate CCW, track 224 is moving in a direction opposite to direction 140.

In some embodiments, MA 222 comprises a mechanical arm 216, which is configured to move together with track 224. Reciprocating pulleys 210, which comprise rollers 211, 212, 213 and 214, are mounted with their respective hinges on arm 216, and are configured to divert ribbon 111 from being moved in direction 140 (before MA 222), to being moved in directions 144 and in directions 160 and 161 (after MA 222) as shown in FIGS. 3A-3C above.

In some embodiments, ribbon 111 is moved in direction 140 into roller 211, and is diverted to direction 144 when it enters into roller 212. Subsequently, ribbon 111 enters rollers 213 and 214 for maintaining the specified tension of ribbon 111 while wiping the residues of printing fluids from nozzles 166, 166a and 166b.

Reference is now made to inset 251 showing MA 255. In some embodiments, MA 255 comprises a gear 246 and a track 244, which are similar to gear 226 and track 224 of MA 222. Gear 246 is coupled to and rotating with shaft 202, so as to move track 244 in direction 240, which are typically parallel to directions 220. Reciprocating pulleys 230 are mounted on a mechanical arm 236, which is moved by track 244 back and forth in direction 240, so as to alternately move roller 111 in directions 160 and 161. Note that gears 226 and 246 are both coupled to shaft 202 so that when processor 20 and/or controller 54 control(s) motor 205 to rotate belt (CW or CCW), tracks 224 and 244 are moving together for moving ribbon 111 in direction 160 or 161 as described above. Moreover, when seam section 45 is not in close proximity to print bar 62, ribbon is moved in direction 144, but is not moved in direction 160 or 161.

In some embodiments, reciprocating pulleys 230 comprise multiple rollers, in the present example, rollers 232 and 233, which are configured to retain the specified tension applied to ribbon 111 when moved in direction 144, and a roller 234 for diverting the direction of ribbon 111. Reciprocating pulleys 230 may comprise additional rollers, such as a roller 235 shown in the general view of FIG. 4, which is configured to divert ribbon 111 to move in direction 150.

In some embodiments, MA 255 comprises an arm 237, which is coupling between arm 236 and roller 234, and is configured to adjust the position of roller 234. In some embodiments, MA 222 may comprise an arm (which is almost completely hidden in inset 201), which is similar to arm 237 and is configured to adjust the position of roller 212. Such arms may be used for replacing ribbon 111 in maintenance operations of WA 200, or for adjusting the tension applied to ribbon 111, or for adjusting the movement direction of ribbon 111, or for any other suitable functionality.

In other embodiments, motor 204 of MA 222 may be coupled directly to pulley 208 for rotating gear 226 and shaft 202.

The particular configuration of WA 200 is shown by way of example, in order to illustrate certain problems that are addressed by embodiments of the present invention and to demonstrate the application of these embodiments in enhancing the performance of such systems. The embodiments of the present invention, however, are by no means limited to this specific sort of example of wiping assembly, and the principles described herein may similarly be applied to any other sorts of mechanisms for controlling the removal of residues of printing fluids from the nozzles of system 10 or from the nozzles and/or other components of other sorts of printing systems.

FIG. 5 is a schematic sectional view of ribbon 111, in accordance with an embodiment of the present invention. In some embodiments, ribbon 111 comprises a core layer 303 made from a textile commercially known as scrim, which is made from cotton or from flax, and is configured to serve as a backbone of ribbon 111 for improving the mechanical properties thereof. For example, core layer 303 is configured to improve the tensile strength of ribbon 111 against the tension applied by WA 200, and to prevent plastic deformations in and/or tearing of ribbon 111.

In some embodiments, core layer 303 comprises arrays of fibers woven and, in the present example, arranged in a crisscross configuration, or intertwined using any other suitable configuration. Core layer 303 is configured to provide ribbon 111 with dimensional stability when WA 200 applies tension to ribbon 111.

In some embodiments, the fibers of core layer 303 may comprise a mixture of polyester and water-based polyurethane.

In some embodiments, ribbon 111 comprises a compressible layer 300, which is configured to contain fluids, such as water 120 and other fluids described herein. Compressible layer 300 has a total thickness between about 300 μm and 900 μm, or any other suitable thickness, in the present example, about 600 μm. Note that when a force, such as a compressible force, is applied to ribbon 111, inter alia, in the Z-axis, for example, in squeezing assembly 110, the thickness of compressible layer 300 is reduced and at least some of the fluids are squeezed out of compressible layer 300. Such embodiments are described in detail, for example, in FIG. 6 below.

In some embodiments, compressible layer 300 may comprise a front layer 302 and a back layer 304, both comprising three-dimensionally entangled polyester ultrafine microfibers and configured to absorb and contain the aforementioned fluids. In the context of the present disclosure and in the claims, the term ultrafine microfibers refers to fibers having a suitable diameter, e.g. between about 2 μm and 6 μm.

In other embodiments, compressible layer 300 may comprise any other suitable type of material, such as polyethylene-based materials.

In some embodiments, the ultrafine microfibers of compressible layer 300 may be impregnated with water-based polyurethane in the spaces between the ultrafine microfibers, so as to impart a soft and highly flexible texture of both front layer 302 and back layer 304 of compressible layer 300. In some embodiments, the microfibers are configured to reduce or prevent static charging, at least when ribbon 111 is moved relative to print bar 62 and/or blanket 44.

In some embodiments, core layer 303 may be integrated with compressible layer 300 using any suitable technique, such as by applying water pressure for merging between compressible layer 300 and core layer 303, or by coupling between core layer 303 and the front and back layers using any suitable techniques. In the example of FIG. 5, front layer 302 has a thickness between about 400 μm and 500 μm, and back layer 304 has a thickness between about 200 μm and 100 μm, respectively, so that the combined thickness of layers 302 and 304 remains about 600 μm. Note that in the present example, layers 302 and 304 constitute compressible layer 300 having core layer 303 positioned therebetween.

In some embodiments, ribbon 111 comprises a wiping layer 301, which is coupled to the surface of front layer 302 using any suitable coupling technique. In the present example, layer 301 is made from a suitable springy material, typically polymer having ultra-low density of fibers. In other embodiments, layer 301 may comprise any other material suitable for wiping residues of the printing fluids from nozzles 166, 166a and 166b. In some embodiments, layer 301 has a thickness between about 50 μm and 500 μm, in the present example, layer 301 has a thickness of about 200 μm.

In some embodiments, ribbon 111 comprises a polyethylene-based layer, referred to herein as a layer 305 having any suitable thickness between about 10 μm and 200 μm. In the present example, layer 305 comprises or is made from polyethylene terephthalate (PET), a commercially denoted polyester, and has a thickness of about 35 μm.

In some embodiments, layer 305 is coupled to back layer 304 of compressible layer 300, using any suitable technique, for example, gluing by applying thermal polyurethane (PTU) or any other suitable type of glue (not shown) between layers 304 and 305.

In some embodiments, the multilayered structure described above provides ribbon 111 with sufficient tensile strength, so that ribbon 111 does not elongate undesirably by undergoing a plastic deformation or creeping of the materials. Note that core layer 303 and layer 305, which is made from PET, improve the mechanical strength of ribbon 111 to remain taut and withstand the tension applied by WA 200. In other words, layers 303 and 305 stiffen ribbon 111 in the X and Y axes, and improve the resistance of ribbon 111 to the tension applied by WA 200.

As described in FIG. 3B above, ribbon 111 is configured to compensate for topographic differences between different nozzles (e.g., nozzles 166a and 166b) of print bar 62, and to adhere to each nozzle of print bar 62 for removing residues therefrom. In some embodiments, the multilayered structure described above provides ribbon 111 with the ability to compensate for the aforementioned topographic differences. In the present example, a combination of (i) layer 301, which is springy, (ii) compressible layer 300, which serves as a reservoir of the water (e.g., water 120) received from CS 100, and (iii) layer 305, is configured to conform to and compensate for topographic differences (e.g., in the Z-axis) between different print heads of print bar 62. The adhesive force of water 120, the flexibility of layer 301, and the tensile strength and flexibility of layer 305 provide ribbon 111 with the self-adhering force, so as to allow contact with nozzle plate 61 and to wipe the residues from all the nozzles (e.g., nozzles 166, 166a and 166b) of print bar 62.

In some embodiments, layer 305 is configured to seal ribbon 111, so as to prevent undesired leakage or dripping of water 120 from ribbon 111 toward the surface blanket 44. Such dripping may cause, inter alia, undesired defects or other distortions within the image formed on blanket 44. Moreover, by preserving the desired amount of water 120 within compressible layer 300, layer 305 improves the self-adhering force of ribbon 111, because the adhesion force of water 120 helps layer 301 (which is wet or humid) to adhere to the nozzle plate of print bar 62, and more specifically, to nozzles 166, 166a and 166b.

In some embodiments, layer 305 seals ribbon 111 also when capping the nozzles when print bar 62 is idle, e.g., not applying droplets of printing fluid to blanket 44, as described in FIG. 3C above. Note that a sufficient amount of water 120 within ribbon 111 is essential for the capping procedure and/or process and for dissolving any residues formed on the nozzles of print bar 62.

The particular configuration and multilayered structure of ribbon 111 is shown by way of example, in order to illustrate certain problems that are addressed by embodiments of the present invention and to demonstrate the application of these embodiments in enhancing the performance of such systems. The embodiments of the present invention, however, are by no means limited to this specific sort of example multilayered structure, and the principles described herein may similarly be implemented using other sorts of materials, number of layers, thickness of each layer, and mechanical, physical and chemical properties of each layer and of the stacked layers. Moreover, the embodiments related to ribbon 111 that are described above, may be applied to any other sorts of printing systems.

FIG. 6 is a schematic sectional view of ribbon 111 squeezed in squeezing assembly 110, in accordance with an embodiment of the present invention. In some embodiments, squeezing assembly 110 comprises drums 112 and 114 described in FIG. 2 above. In the present example, roller 114 rotates CW as shown by an arrow 311, and drum 112 rotates CCW as shown by an arrow 312.

In some embodiments, when ribbon 111 is pulled out of WC 122f, at least compressible layer 300 is soaked with water 120 and having a thickness of about 600 μm or even a higher thickness due to the volume captured with water 120. In some embodiments, when soaked, compressible layer 300 is configured to contain between about 300 grams per square meter (g/m²) and 950 g/m² of water 120. In the present example, compressible layer 300 contains about 575 g/m².

In some embodiments, when ribbon 111 is inserted between drums 112 and 114, the thickness of compressible layer 300 is reduced to any suitable thickness between about 150 μm and 350 μm. In the present example, the thickness of compressible layer 300 is reduced to a thickness 310 of about 250 μm, and the amount of water 120 contained within compressible layer 300 is reduced to about 225 g/m².

In other words, in the present example, approximately 60% of water 120 is squeezed out of ribbon 111. Note that ribbon 111 is flexible, and therefore, after ribbon 111 exits from squeezing assembly 110, cavities within compressible layer 300 (and other layers of) ribbon 111 are typically filled with environmental fluids, such as but not limited to air surrounding squeezing assembly 110. Moreover, when ribbon 111 is moved between blanket 44 and image forming station 60, compressible layer 300 (and other layers of) ribbon 111 are configured to absorb aerosols and vapors of printing fluids present between blanket 44 and print bar 62.

Based on the embodiments described above, when moved within the gap (e.g., gap 141 shown in FIG. 2 above) between blanket 44 and image forming station 60 along the bottom section of the nozzle plate, ribbon 111 is configured to perform at least one of the following operations: (i) adhere to all the nozzles of print bar 62 and be moved in directions 144 and/or 160 for wiping residues of printing fluids from nozzles 166, 166a and 166b, (ii) absorb and contain various types of vapors and aerosols that may undesirably be deposited on one or more of nozzles 166, 166a and 166b, (iii) retain some humidity on the surface of nozzles 166, 166a and 166b and sections 170 and 172 of print bar 62, to prevent undesired deposition and/or solidification of materials surrounding print bar 62, (iv) buffer between nozzles 166, 166a and 166b and the aforementioned environment, in particular when print bar 62 is not applying droplets of printing fluids toward blanket 44 (e.g., when print bar 62 and possibly system 10 are both in idle and/or standby positions), and (v) remove the aforementioned residues and other contaminants in water containers 122 of cleaning station 100.

In some embodiments, processor 20 and/or controller 54 are configured to control the amount of water 120 remaining in ribbon 111 after the squeezing, by controlling the distance between drums 112 and 114 (also referred to herein as rollers). For example, the distance between drums 112 and 114 is controlled by applying a force in a direction 315, e.g., by piston 117 and shaft 119 described in FIG. 2 above.

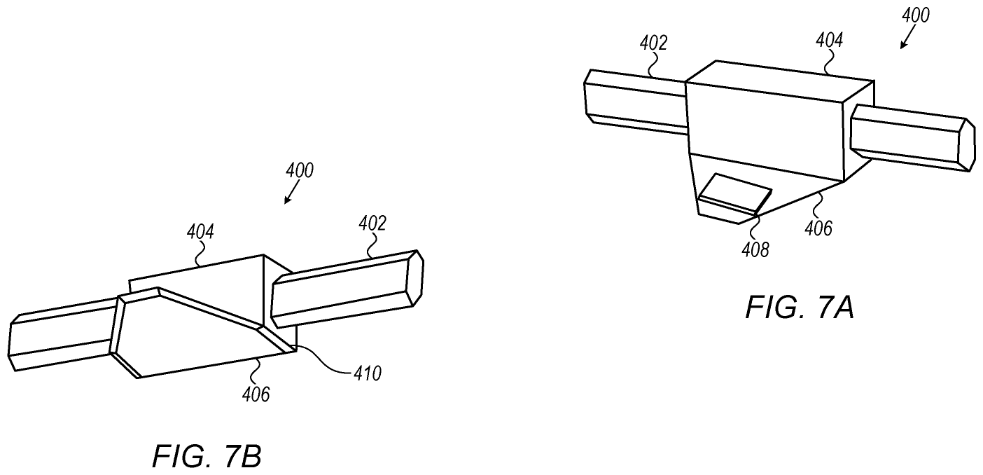

FIG. 7A is a schematic pictorial illustration of a wiping assembly (WA) 400 shown in top-view, in accordance with another embodiment of the present invention. In some embodiments, WA 400 may be used in system 10 instead of or in addition to WA 200 described in FIGS. 2-4 above.

In some embodiments, WA 400 comprises a track 402, which may have a longitudinal axis parallel to a Y-axis or at any other orientation. WA 400 comprises a slider 404, which is configured to be moved in Y-axis, and to slide along track 402.

In some embodiments, WA 400 comprises a blade 406, which is made from a light and durable material, such as tungsten carbide, and is coupled to slider 404, for example, using an adhesive bond.

In some embodiments, WA 400 comprises a wiper pad 408, which is coupled to blade 406, e.g., by gluing. Wiper pad 408 is made from any material suitable for removing residues of the printing fluids from nozzles 166, 166a and 166b of print bar 62.

In some embodiments, when moved along print bar 62, blade 406 of WA 400 is configured to push wiper pad 408 toward nozzles 166, 166a and 166b of print bar 62, so as to compensate for topographic differences (e.g., in the Z-axis) between different print heads of print bar 62, as described in FIGS. 3B and 5 above.

In some embodiments, after wiping nozzles 166, 166a and 166b of print bar 62, wiper pad 408 may be cleaned for removing the aforementioned residues, using any suitable techniques.

FIG. 7B is a schematic pictorial illustration of WA 400 shown in bottom-view, in accordance with another embodiment of the present invention.

In some embodiments, blade 406 has a first edge coupled to slider 404 and a second edge coupled to wiper pad 408. This configuration allows motion of the second edge in the Z-axis so as to conform to the topography of the print heads of print bar 62.

The particular configuration of WA 400 is shown by way of example, in order to illustrate certain problems that are addressed by embodiments of the present invention and to demonstrate the application of these embodiments in enhancing the performance of such systems. The embodiments of the present invention, however, are by no means limited to this specific sort of example wiping assembly 400, and the principles described herein may similarly be applied to any other sorts of residues removal apparatus.

In other embodiments, the wiper pad may be mounted on a cable (not shown), with or without the blade or any other suitable carrier. In such embodiments, the cable may be moved using rollers and/or pulleys and/or drums and/or any other suitable type of apparatus.

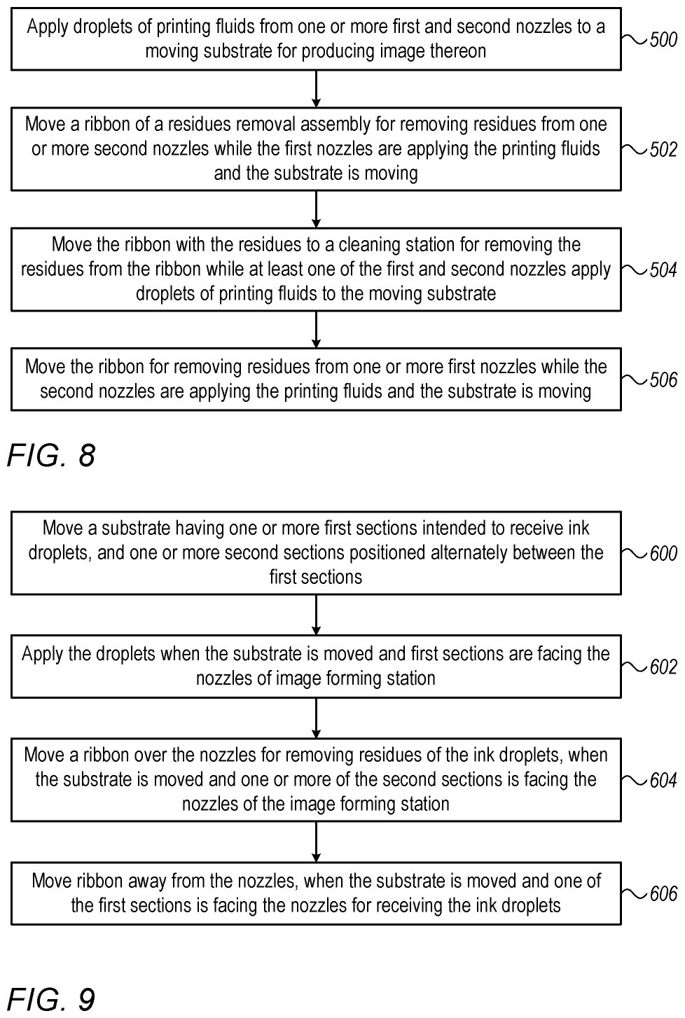

FIG. 8 is a flow chart that schematically illustrates a method for removing residues from nozzles 166, 166a and 166b of one or more print bars 62 of system 10, in accordance with an embodiment of the present invention.

The method begins at a printing step 500, with applying droplets of printing fluids from one or more first and second nozzles to a moving substrate for producing an image thereon. In the present example, the moving substrate comprises blanket 44, which is an intermediate transfer member. In other embodiments, the moving substrate may comprise a target substrate, such as one or more sheets or a continuous web, which receives the image directly from the nozzles of the print bar. Such embodiments may be implemented in direct printing systems.

In some embodiments, the first nozzles may be positioned in a first print bar 62, and the second nozzles may be positioned in a second, different, print bar 62 of system 10. Note that each print bar 62 has a separate WA 200 comprising a separate ribbon 111 for wiping the residues from the nozzles of the respective print bar. In the context of the present description, a first WA 200 is configured to wipe the nozzles of a first print bar 62, and a second WA 200 is configured to wipe the nozzles of a second print bar 62.

At a first residues removal step 502, processor 20 and/or controller 54 move ribbon 111 of a second WA 200 (or any other sort of a residues removal assembly) for removing residues from one or more second nozzles (e.g., nozzles 166 166a and 166b of the second print bar) while the first nozzles (e.g., of the first print bar) are applying the printing fluids and the substrate (e.g., blanket 44) is moving.

Note that steps 500 and 502 may be carried out simultaneously. In some embodiments, when one or more first nozzles of a first print bar 62 of system 10 are applying the droplets of printing fluids to blanket 44, ribbon 111 of the second WA 200 is wiping residues of the printing fluids from one or more second nozzles of a second print bar 62 of system 10. For example, the nozzles of the magenta print bar may apply the magenta ink to blanket 44, and at the same time, WA 200 of the cyan print bar may move ribbon 111 in both directions 144 and 160, for wiping residues of cyan ink from the nozzles of the cyan print bar. As described in FIGS. 3A-3C above, wiping the nozzles of the cyan print bar may be carried out while seam section 45 is positioned between blanket 44 the cyan print bar, shown as print bar 62, for example, in FIGS. 3A-3C above.

At a residues cleaning step 504, processor 20 and/or controller 54 are configured to move ribbon 111, which carries the residues removed from the nozzles of the cyan print bar to a cleaning station (e.g., CS 100) for removing the residues from ribbon 111, while at least one of the magenta and cyan nozzles apply droplets of printing fluids to blanket 44.

In other embodiments, instead of cleaning the residues from ribbon 111, WA 200 may comprise two drums (not shown). A first drum supplies a clean ribbon 111 for wiping the residues from print bar 62, and a second drum, for receiving ribbon 111 after wiping the residues from print bar 62. Note that the clean ribbon may be moved through a reservoir of cleaning fluids, such as water 120, and a squeezing assembly (e.g., squeezing assembly 110) for containing a predefined amount of water 120 within compressible layer 300 of ribbon 111. As described in FIGS. 2 and 5 above, the water contained within compressible layer 300 may be used for adhering ribbon 111 to all the nozzles of print bar 62, and for removing the residues from the nozzles.

At a second residues removal step 506 that concludes the method, processor 20 and/or controller 54 move ribbon 111 of WA 200 (or any other sort of a residues removal assembly) for removing residues from one or more first nozzles (e.g., the nozzles of the magenta print bar) while the second nozzles (e.g., the nozzles of the cyan print bar) are applying the printing fluids (e.g., cyan ink) to blanket 44, which is moving for producing the ink image.

In the embodiments described above, each print bar 62 has a separate WA 200, so that when seam section 45 passes between a given print bar 62, a given WA 200 of the given print bar 62 is wiping the residues of the printing fluids from the nozzles of the given print bar 62, while the nozzles (e.g., nozzles 166, 166a and 166b) of one or more of the other print bars 62 continue to apply the printing fluids to blanket 44 in accordance with the printing scheme of the particular image formed on blanket 44.

Therefore, it will be understood that the steps 500-506 of the method described in FIG. 8 may be carried out in multiple cycles. The cycles may be carried out at least as long as image forming system 60 is applying any type of droplets (such as but not limited to ink) to blanket 44. Moreover, one or more of steps 500-506 may be carried out simultaneously.

For example, in one implementation, the residues wiping of step 502 may be carried out in one section of ribbon 111, while another section of ribbon 111 is being cleaned as described in step 504. In another implementation, the residues wiping may be carried out on a first print bar 62, while one or more nozzles of one or more of the other print bars 62 of system 10 are applying the respective printing fluids to blanket 44, as described in steps 502 and 506 of the method.

In some embodiments, the techniques disclosed in the method of FIG. 8, and also described in detail in FIGS. 2-6 above, improve the productivity of system 10 by performing maintenance on-the-fly, i.e., when system 10 is printing images on blanket 44 and/or transferring the images to the target substrate, such as but not limited to sheet 50.

FIG. 9 is a flow chart that schematically illustrates a method for forming images and removing residues from nozzles 166, 166a and 166b of print bar 62, in accordance with an embodiment of the present invention.

The method begins at a substrate moving step 600, with moving a suitable intermediate or target substrate along moving direction 94. In the present example, the substrate comprises blanket 44 having one or more first sections, each first section is intended to receive the ink droplets for forming the aforementioned image thereon, as described in detail, for example, in FIG. 1 above.

In some embodiments, blanket 44 further comprises one or more second sections, which are positioned alternately between the first sections. The second sections are not receiving droplets of ink or other printing fluids, and are not intended for forming ink images thereon. In such embodiments, one of the second sections may comprise seam section 45.

Note that due to the alternating arrangement of the first and second sections, when blanket 44 is moved in moving direction 94, the first and second sections pass alternately adjacent to print bar 62. In other words, when blanket 44 is moved in direction 94, a first section is facing print bar 62 at a first-time interval, and at a second time interval that follows the first time interval, a second section is facing print bar 62. This sequence recurs (along the endless loop of blanket 44) as long as blanket 44 is moved in moving direction 94, so that the next first section is facing print bar 62, and subsequently, the next second section is facing print bar 62.

At an image formation step 602, when blanket 44 moves in moving direction 94 and one of the first sections of blanket 44 is facing print bar 62, nozzles 166, 166a and 166b are applying (e.g., jetting) the printing fluid (in the present example ink droplets) to the surface of the first section facing print bar 62.

At a residues removal step 604, while blanket 44 is moved in direction 94 and one of the second sections of blanket 44 is facing nozzles 166 166a and 166b of print bar 62, processor 20 and/or controller 54 move ribbon 111 at least in direction 160 (e.g., using the discrete motion profile described in FIGS. 3A-3B above), and typically also in direction 144 (e.g., using the continuous motion profile described in FIGS. 3A-3B above), for removing residues of the printing fluids from nozzles 166 166a and 166b of print bar 62. Note that step 604 may be carried out using any suitable frequency, for example, blanket 44 may have eleven (11) first sections and eleven (11) second sections.

In a first implementation, step 604 may be carried out when each of the second sections is facing print bar 62 (i.e., after forming every image, and eleven times for every cycle of blanket 44, defined when seam section 45 passes adjacent to print bar 62). In a second implementation, step 604 may be carried out when every fifth second section is facing print bar 62 (i.e., typically twice for every cycle of blanket 44). In a third implementation, step 604 may be carried out solely when seam section 45 is facing print bar 62 (i.e., once for every cycle of blanket 44).

Additionally, or alternatively, step 604 may be carried out using any other suitable scheduling or frequency, such as every predefined time interval. For example, every about ten seconds, or about thirty seconds, or about five minutes or about one hour. Note that the frequency may be constant, or may alter in conjunction with other operations, e.g., between preventive maintenance (PM) operations, carried out on system 10. For example, relatively low frequency (e.g., every ten minutes) in the first day after the PM, and higher frequency (e.g., every five minutes) in the last day before the next PM.

In other embodiments, when print bar 62 is in idle position (e.g., not applying ink to blanket 44), WA 200 is configured to position ribbon 111 over the nozzles of print bar 62, so as to prevent solidification of the printing-fluid residues or any other undesired substance, on nozzles 166, 166a and 166b, and/or on the orifice(s) thereof.

At a ribbon removal step 606 that concludes the method, WA 200 moves ribbon 111 away from the nozzles of print bar 62. In some embodiments, step 606 is typically carried out when blanket 44 is moved and one of the first sections is facing the nozzles of print bar 62 for receiving ink droplets and forming the image, as described for example in FIGS. 3A-3B above.

Although the embodiments described herein mainly address digital printing systems having intermediate transfer members, the methods and systems described herein can also be used in other applications, such as in any sort of direct printing systems using inkjet nozzles for two-dimensional and three-dimensional printing applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that, to the extent any terms are defined in these incorporated documents in a manner that conflicts with the definitions made explicitly or implicitly in the present specification, only the definitions in the present specification should be considered.

1. A system having a printing position and a non-printing position, the system comprising:
an image forming station comprising at least a nozzle plate having one or more nozzles, which are configured to apply droplets of a printing fluid onto a surface of one or more substrates for producing one or more images thereon; and
a wiping assembly, which is at least partially positioned in a gap between the nozzle plate and the one or more substrates, and is configured, while the system is in the printing position, to (i) make physical contact with the nozzle plate and (ii) remove residues of the printing fluid from at least one of the nozzles.

2. The system according to claim 1, and comprising (i) a transport assembly, which is configured to move the one or more substrates relative to the nozzle plate, and (ii) a processor, which is configured to control: (a) the transport assembly to move the one or more substrates, and (b) the wiping assembly to remove the residues from at least one of the nozzles while the one or more substrates are moved by the transport assembly.

3-6. (canceled)

7. The system according to claim 1, wherein, in the printing position, the gap between the nozzle plate and the one or more substrates is retained while (i) applying the droplets, and (ii) removing the residues.

8. The system according to claim 2, wherein the wiping assembly comprises a wiping element, which is configured to remove the residues by wiping the residues of the printing fluids from at least an orifice of at least one of the nozzles.

9. The system according to claim 8, wherein the wiping element comprises a ribbon, which is configured to hold a cleaning fluid and to make the physical contact with the nozzle plate by self-adhering to the nozzle plate.

10. The system according to claim 9, wherein the ribbon comprises: (a) a residues-removing layer, which is configured to remove residues of printing fluids from the nozzle plate, and (b) a compressible layer, which is coupled to the residues-removing layer, and is configured to: (i) absorb and contain a cleaning fluid when placed in contact with the cleaning fluid, and (ii) release at least part of the cleaning fluid when a compression force is applied to the ribbon.

11-15. (canceled)

16. The system according to claim 8, wherein the wiping assembly is configured to move the wiping element in a first direction during a first-time interval, and in a second direction during a second-time interval.

17. The system according to claim 16, wherein the nozzles are arranged along a first axis and across a second axis, and wherein at least one of: (i) the first direction is parallel to the first axis, and (ii) the second direction is parallel to the second axis.

18. (canceled)

19. The system according to claim 16, wherein the processor is configured to control the wiping assembly to move the wiping element in at least one of the first and second directions when at least one of the nozzles is jetting the printing fluids toward the one or more substrates.

20. The system according to claim 16, wherein the first-time interval is larger than the second-time interval.

21. The system according to claim 16, wherein the first-time interval overlaps with one or more second-time intervals.

22. The system according to claim 16, wherein the first direction is orthogonal to the second direction.

23. The system according to claim 16, wherein the processor is configured to control the wiping assembly to move the wiping element (i) at a first speed in the first direction, and (ii) at a second speed, which is different from the first speed, in the second direction.

24. (canceled)

25. The system according to claim 16, wherein the one or more substrates comprise a flexible substrate having a first section for receiving the one or more printing fluids and a second section positioned between the first and second images, and wherein the processor is configured to control (i) the flexible substrate to be moved in a moving direction, and (ii) the wiping assembly to move the wiping element in the second direction, which is parallel to the moving direction of the flexible substrate, when the second section passes adjacent to one or more nozzles.

26-44. (canceled)

45. A ribbon, comprising:
a residues-removing layer, which is configured to remove residues of printing fluids from one or more nozzles of a printing system; and
a compressible layer, which is coupled to the residues-removing layer, and is configured to: (i) absorb and contain a cleaning fluid when placed in contact with the cleaning fluid, and (ii) release at least part of the cleaning fluid when a compression force is applied to the ribbon.

46. The ribbon according to claim 45, wherein the one or more nozzles are formed in a nozzle plate, and wherein the residues-removing layer is configured to receive at least part of the cleaning fluid from the compressible layer, and to self-adhere to the nozzle plate for making a physical contact with the one or more nozzles.

47. The ribbon according to claim 45, and comprising a core layer, which is coupled to the compressible layer, and is configured to stiffen the ribbon in a given plane when a tension force is applied to the ribbon.

48. The ribbon according to claim 47, wherein the core layer is implemented within the fluid-containing layer such that the fluid-containing layer has first and second outer surfaces facing one another, and the core layer is positioned between the first and second surfaces.

49. The ribbon according to claim 48, wherein the first outer surface is coupled to the residues-removing layer, and comprising a polyethylene-based layer, which is coupled to the second outer surface of the fluid-containing layer, and is configured to perform at least one of: (i) stiffen the ribbon in the given plane when the tension force is applied to the ribbon, and (ii) retain at least part of the cleaning fluid within the fluid-containing layer when the compression force is not applied to the ribbon.

50-51. (canceled)

52. The ribbon according to claim 49, wherein the printing system comprises a first nozzle having first printing residues and a second nozzle having second printing residues, and wherein at least one of the residues-removing layer and the fluid-containing layer is configured to compensate for a topographic difference between the first and second nozzles, so as to adhere between (i) the residues-removing layer and (ii) at least the first and second nozzles, for removing the first and second printing residues.

53-77. (canceled)
